(19) United States
(12) Patent Application Publication
(10) Pub. No.: US 2019/0094408 A1
(43) Pub. Date: Mar. 28, 2019

(54) IMAGING THROUGH MEDIA USING ARTIFICIALLY-STRUCTURED MATERIALS

(71) Applicant: Duke University, Durham, NC (US)

(72) Inventors: Michael Boyarsky, Durham, NC (US); Seyedmohammadreza Faghih Imani, Durham, NC (US); Daniel L. Marks, Durham, NC (US); Timothy Sleasman, Durham, NC (US); David R. Smith, Durham, NC (US); Okan Yurduseven, Pasadena, CA (US)

(21) Appl. No.: 16/138,798

(22) Filed: Sep. 21, 2018

Related U.S. Application Data
(60) Provisional application No. 62/561,864, filed on Sep. 22, 2017.
(60) Provisional application No. 62/561,872, filed on Sep. 22, 2017.

(51) Int. Cl. G01V 5/00; G06T 5/00

(52) U.S. Cl. CPC G01V 5/0025; G06T 7/136; G06T 2207/20192; G06T 5/003

(57) ABSTRACT

According to various embodiments, systems and methods for through imaging a medium are disclosed. An apparatus can include one or more radiating elements comprising one or more artificially-structured materials. The one or more radiating elements can be configured to transmit a radiation pattern of electromagnetic energy into a medium. The apparatus also can include one or more receiving elements configured to receive backscattered energy from the radiation pattern of electromagnetic energy transmitted into the medium. The backscattered energy received by the one or more receiving elements can be used to generate one or more through images of the medium.

### CROSS-REFERENCE TO RELATED APPLICATIONS

The present application claims the benefit of the earliest available effective filing date(s) from the following listed application(s) (the “Priority Applications”), if any, listed below (e.g., claims earliest available priority dates for other than provisional patent applications or claims benefits under 35 USC § 119(e) for provisional patent applications, for any and all parent, grandparent, great-grandparent, etc. applications of the Priority Application(s)).

### PRIORITY APPLICATIONS

This application claims priority under 35 U.S.C. § 119(e) to Provisional Patent App. No. 62/561,872, filed on Sep. 22, 2017, titled “Dynamic Metasurface Antennas for Imaging Through Media and Systems and Methods for Using Same,” and Provisional Patent App. No. 62/561,864, filed on Sep. 22, 2017, titled “Systems and Methods for Imaging Through Media,” both of which are hereby incorporated by reference in their entirety.

If an Application Data Sheet (ADS) has been filed on the filing date of this application, it is incorporated by reference herein. Any applications claimed on the ADS for priority under 35 U.S.C. §§ 119, 120, 121, or 365(c), and any and all parent, grandparent, great-grandparent, etc., applications of such applications are also incorporated by reference, including any priority claims made in those applications and any material incorporated by reference, to the extent such subject matter is not inconsistent herewith.

### TECHNICAL FIELD

The present disclosure generally relates to imaging, and more particularly, to systems and methods for imaging through media using artificially structured materials.

### BACKGROUND

Imaging through optically opaque materials is of interest for a variety of applications including disaster response, police awareness, and inspection of residential houses/buildings. While optical and infrared light cannot penetrate the relevant materials (e.g drywall, wood, concrete) to sense objects on the other side, microwave and radio frequencies often can. To obtain desirable resolutions at these frequencies, large apertures must be created which often leads to expensive and bulky imaging systems. There, therefore exist needs for systems and methods for imaging through media that are practical for operation by a user without being overly expensive.

Further, when imaging an object through an inhomogeneous medium, the medium can distort the field passing through the medium. In turn, this can reduce the fidelity of the resulting image. In some instances where the structure of the medium is known, this structure can be included in the model of the imaging system so that its effects may be accounted for. However, in many practical situations, both the object to be imaged and the structure of the intervening medium are unknown. Unfortunately, the medium then adds confounding variables so that the scattered field sampled by the sensor may no longer be sufficient to determine both the medium and object structures. Layered planar media, however, are relatively simple, because these may be described by a one-dimensional function of the medium composition with depth, and because planar structures are symmetric about the axis normal to the surface planes. Therefore the types of distortions that may be produced by planar media are highly restricted as compared to three-dimensional media. Artificial structures such as building walls are often built as layered structures, so that accounting for the propagation through these layers is likely to remove much of the distortions produced by the wall.

Additionally, layered structures, despite their simplicity, can produce a number of effects including interference effects and Newton's rings, total internal reflection and evanescent fields, and surface waves. Despite these complex effects, the response of a medium to plane wave radiation may be summarized as a function of the temporal frequency, the incident angle to the surface, and whether the radiation is polarized in the plane of incidence or perpendicular to it. As a medium is completely rotationally symmetric around the axis normal to the surface layers, so is its response to incoming radiation. This strongly constrains the types of distortions that can occur when propagating through media.

To preserve circular symmetry when irradiated by an antenna, one might consider the field a point radiation source placed on one side of the media might produce on the other side, in other words, the Green's function of a medium. The medium is both translationally invariant and rotationally symmetric about its axis, and therefore propagation through the medium is calculated as a convolution with a circularly symmetric Green's function. Because only the perpendicular or parallel polarizations are rotationally symmetric, a point source that unequally excites the polarizations does not produce a rotationally symmetric field. For a point source, the only three rotationally symmetric polarization states with respect to the layered structure is the linear polarization pointing along the symmetry axis, and the left and right circular polarizations in the plane perpendicular to the symmetry axis. Unfortunately, all three of these polarization states have disadvantages when measuring the scattered signal from a layered structure in a reflection geometry. The linearly polarized source along the symmetry axis does not radiate at all in the direction along the symmetry axis. The scattered field of the two circular polarizations reverses upon reflection, so that right-circular polarization becomes left-circular polarization and vice-versa, and therefore an antenna radiating one polarization rejects the reflected orthogonal polarization.

A point source linearly polarized along the layer planes does not produce a rotationally symmetric Green's function as it projects unequally onto parallel and perpendicular incident polarizations and does not radiate equally into all angles around the symmetry axis. However, as the transmission of the field near the axis is weakly dependent on the polarization, the Green's function is often nearly rotationally symmetric. One may regard the true asymmetric Green's function as the convolution of a “best fit” rotationally symmetric convolution kernel and an asymmetric error kernel. Typically most of the distortion is due to the rotationally symmetric kernel, and therefore compensation for this rotationally symmetric component removes most of the distortion. In particular, while the transmission and reflection coefficients at each interface depend on the incident polarization state, the propagating phase between the interfaces does not, and often much of the distortion depends on the interference effects between interfaces that are largely determined by the propagation phase.

Given that a suitable rotationally symmetric approximation to the medium Green's function exists, by using deconvolution the object reflectivity may be estimated from the backscattered signal. Blind deconvolution methods attempt to infer the convolution kernel directly from measured data. If the convolution kernel, or Green's function, of the medium is inferred from the measurements, this obviates the need to know the medium composition. Without any constraints, the reconstruction of the object could be that produced by deconvolution by the Green's function of any plausible medium. Many objects of interest are not translationally or rotationally invariant and so the object can be assumed to be the minimally symmetric solution with all of the symmetric broadening or blurring attributed to the medium. A sparsity constraint is placed on the object to achieve the minimally broadened solution. However, objects with repetitive annular structure may have their structure incorrectly attributed to the Green's function. For the kinds of objects expected to be inside walls, such as metal pipes or conduit boxes, this is not likely to occur.

There therefore, exist needs for systems and methods for imaging through media absent knowledge of the characteristics of the media being imaged.

### SUMMARY

According to various embodiments, an apparatus for performing through medium imaging can include one or more radiating elements comprising one or more artificially-structured materials. The one or more radiating elements can be configured to transmit a radiation pattern of electromagnetic energy into a medium. The apparatus also can include one or more receiving elements configured to receive backscattered energy from the radiation pattern of electromagnetic energy transmitted into the medium. The backscattered energy received by the one or more receiving elements can be used to generate one or more through images of the medium.

In various embodiments, a method for performing through medium imaging comprises transmitting, using one or more radiating elements of an apparatus, a radiation pattern of electromagnetic energy into a medium as the apparatus remains static. The one or more radiating elements can comprise one or more artificially-structured materials. The method can also include receiving, using one or more receiving elements of the apparatus, backscattered energy from the radiation pattern of electromagnetic energy transmitted into the medium. The backscattered energy can be used to generate one or more through images of the medium as the apparatus remains static.

In certain embodiments, a method for performing through medium imaging comprises transmitting, using one or more radiating elements of an apparatus, a radiation pattern of electromagnetic energy into a medium as the apparatus is moved in relation to the medium. The one or more radiating elements can comprise one or more artificially-structured materials. The method can also include receiving, using one or more receiving elements of the apparatus, backscattered energy from the radiation pattern of electromagnetic energy transmitted into the medium. The backscattered energy can be used to generate one or more through images of the medium as the apparatus is moved in relation to the medium.

In various embodiments, blind deconvolution can be applied to generate one or more through images of a medium. Blind deconvolution can be applied to generate the images from backscattered energy received at one or more receiving elements from the medium in response to a radiation pattern of electromagnetic energy transmitted into the medium. The radiation pattern of electromagnetic energy can be transmitted into the medium from one or more radiating elements comprising one or more artificially-structured materials. Both the receiving elements and the radiating elements can be integrated as part of an apparatus.

In certain embodiments, a through medium imaging system comprises a processor and a computer-readable medium providing instructions accessible to the processor. The instructions can cause the processor to perform operations for generating a through image of the medium. Specifically, the instruction can cause the processor to apply blind deconvolution to generate one or more through images of the medium from backscattered energy received at one or more receiving elements. The backscattered energy can be received from the medium in response to a radiation pattern of electromagnetic energy transmitted into the medium from one or more radiating elements comprising one or more artificially-structured materials. Both the receiving elements and the radiating elements can be integrated as part of an apparatus.

### BRIEF DESCRIPTION OF THE DRAWINGS

FIG. 1 illustrates an example imaging apparatus 100 for imaging through media.

FIG. 2A shows a front view of an example imaging apparatus with a plurality of separate elements that form radiating elements and receiving elements.

FIG. 2B shows a back view of the example imaging apparatus.

FIG. 3 is a flowchart of an example method of generating through images based of a medium energy backscattered from one or more electromagnetic radiation patterns transmitted into the medium.

FIG. 4 shows a representation of a nearly circularly symmetric Green's function produced by a linearly polarized dipole through a medium.

FIG. 5A shows a true point spread function of a simulation.

FIG. 5B shows the true modulation transfer function of the simulation.

FIG. 5C shows the estimated point spread function of the simulation.

FIG. 5D shows the estimated modulation transfer function of the simulation.

FIG. 5E shows the magnitude of the synthetic data of the simulation.

FIG. 5F shows the reconstruction of the data of the simulation.

FIG. 6A shows a wall.

FIG. 6B shows the wall phantom scanned by the antennas.

FIG. 7A shows the magnitude of the original data for the wall.

FIG. 7B shows the deconvolution data for the wall.

FIG. 7C shows the estimated point spread function for the wall.

FIG. 7D shows the estimated modulation transfer function for the wall.

FIG. 8A, shows a DUKE object behind a plywood wall.

FIG. 8B the corresponding phantom being scanned through the plywood wall.

FIG. 9A shows the original data for the DUKE object.

FIG. 9B shows the deconvolution data for the DUKE object.

FIG. 9C shows the estimated point spread function for the DUKE object.

FIG. 9D shows the estimated modulation transfer function for the DUKE object.

FIG. 10A shows a cross object behind particle board layers.

FIG. 10B is the corresponding phantom being scanned.

FIG. 11A shows the original data for the cross-shaped target.

FIG. 11B shows the deconvolution data for the cross-shaped target.

FIG. 11C shows the estimated point spread function for the cross-shaped target.

FIG. 11D shows the modulation transfer function for the cross-shaped target.

FIG. 12A shows a front perspective view of an example imaging apparatus.

FIG. 12B shows a back perspective view of an example imaging apparatus.

FIG. 13 shows an environment in which an imaging apparatus is operated.

### DETAILED DESCRIPTION

The subject disclosure describes improved systems and methods for performing imaging. Specifically, the subject disclosure describes improved systems and methods for imaging through media. Further, the subject disclosure describes improved systems and methods for imaging through media without knowledge of the characteristics of the media. While certain applications are discussed in greater detail herein, such discussion is for purposes of explanation, not limitation.

Embodiments of the imaging systems and methods described herein can be realized using artificially-structured materials. Generally speaking, the electromagnetic properties of artificially-structured materials derive from their structural configurations, rather than or in addition to their material composition.

In some embodiments, the artificially-structured materials are metamaterials. Some exemplary metamaterials are described in R. A. Hyde et al., “Variable metamaterial apparatus.” U.S. patent application Ser. No. 11/355,493: D. Smith et al., “Metamaterials.” International Application No. PCT/US2005/026052: D. Smith et al., “Metamaterials negative refractive index.” Science 305,788 (2004); D. Smith et al., “Indefinite materials. U.S. patent application Ser. No. 10/525,191; C. Caloz, and T. Itoh, Electromagnetic Metamaterials. Transmission Line Theory and Microwave Applications, Wiley-Interscience, 2006; N. Engheta and R. W. Ziolkowski, eds., Metamaterials. Physics and Engineering Explorations, Wiley-Interscience, 2006; and A. K. Sarychev and V. M. Shalaev, Electrodynamics of Metamaterials, World Scientific, 2007; each of which is herein incorporated by reference.

Metamaterials generally feature subwavelength elements, i.e. structural elements with portions having electromagnetic length scales smaller than an operating wavelength of the metamaterial. In some metamaterials, the subwavelength elements may have a collective response to electromagnetic radiation that corresponds to an effective continuous medium response, characterized by an effective permittivity, an effective permeability, an effective magnetoelectric coefficient, or any combination thereof. For example, the electromagnetic radiation may induce charges and/or currents in the subwavelength elements, whereby the subwavelength elements acquire nonzero electric and/or magnetic dipole moments. Where the electric component of the electromagnetic radiation induces electric dipole moments, the metamaterial has an effective permittivity; where the magnetic component of the electromagnetic radiation induces magnetic dipole moments, the metamaterial has an effective permeability; and where the electric (magnetic) component induces magnetic (electric) dipole moments (as in a chiral metamaterial), the metamaterial has an effective magnetoelectric coefficient. Some metamaterials provide an artificial magnetic response; for example, split-ring resonators (SRRs)—or other LC or plasmonic resonators—built from nonmagnetic conductors can exhibit an effective magnetic permeability (c.f. J. B. Pendry et al, “Magnetism from conductors and enhanced nonlinear phenomena,” IEEE Trans. Micro. Theo. Tech. 47, 2075 (1999), herein incorporated by reference). Some metamaterials have “hybrid” electromagnetic properties that emerge partially from structural characteristics of the metamaterial, and partially from intrinsic properties of the constituent materials. For example, G. Dewar, “A thin wire array and magnetic host structure with n<0,” J. Appl. Phys. 97, 10Q101 (2005), herein incorporated by reference, describes a metamaterial consisting of a wire array (exhibiting a negative permeability as a consequence of its structure) embedded in a nonconducting ferrimagnetic host medium (exhibiting an intrinsic negative permeability). Metamaterials can be designed and fabricated to exhibit selected permittivities, permeabilities, and/or magnetoelectric coefficients that depend upon material properties of the constituent materials as well as shapes, chiralities, configurations, positions, orientations, and couplings between the subwavelength elements. The selected permittivites, permeabilities, and/or magnetoelectric coefficients can be positive or negative, complex (having loss or gain), anisotropic, variable in space (as in a gradient index lens), variable in time (e.g. in response to an external or feedback signal), variable in frequency (e.g. in the vicinity of a resonant frequency of the metamaterial), or any combination thereof. The selected electromagnetic properties can be provided at wavelengths that range from radio wavelengths to infrared/visible wavelengths; the latter wavelengths are attainable, e.g., with nanostructured materials such as nanorod pairs or nano-fishnet structures (c.f. S. Linden et al, “Photonic metamaterials: Magnetism at optical frequencies,” IEEE J. Select. Top. Quant. Elect. 12, 1097 (2006) and V. Shalaev, “Optical negative-index metamaterials,” Nature Photonics 1, 41 (2007), both herein incorporated by reference). An example of a three-dimensional metamaterial at optical frequencies, an elongated-split-ring “woodpile” structure, is described in M. S. Rill et al, “Photonic metamaterials by direct laser writing and silver chemical vapour deposition,” Nature Materials advance online publication, May 11, 2008, (doi:10.1038/nmat2197).

While many exemplary metamaterials are described as including discrete elements, some implementations of metamaterials may include non-discrete elements or structures. For example, a metamaterial may include elements comprised of sub-elements, where the sub-elements are discrete structures (such as split-ring resonators, etc.), or the metamaterial may include elements that are inclusions, exclusions, layers, or other variations along some continuous structure (e.g. etchings on a substrate). Some examples of layered metamaterials include: a structure consisting of alternating doped/intrinsic semiconductor layers (cf. A. J. Hoffman, “Negative refraction in semiconductor metamaterials,” Nature Materials 6, 946 (2007), herein incorporated by reference), and a structure consisting of alternating metal/dielectric layers (cf. A. Salandrino and N. Engheta, “Far-field subdiffraction optical microscopy using metamaterial crystals: Theory and simulations,” Phys. Rev. B 74, 075103 (2006); and Z. Jacob et al, “Optical hyperlens: Far-field imaging beyond the diffraction limit,” Opt. Exp. 14, 8247 (2006); each of which is herein incorporated by reference). The metamaterial may include extended structures having distributed electromagnetic responses (such as distributed inductive responses, distributed capacitive responses, and distributed inductive-capacitive responses). Examples include structures consisting of loaded and/or interconnected transmission lines (such as microstrips and striplines), artificial ground plane structures (such as artificial perfect magnetic conductor (PMC) surfaces and electromagnetic band gap (EGB) surfaces), and interconnected/extended nanostructures (nano-fishnets, elongated SRR woodpiles, etc.).

The artificially-structured materials, as described herein, can be arranged on either a surface of a waveguide or on a surface of a cavity. Specifically, the artificially-structured materials can be arranged on either a surface of a waveguide or on a surface of a cavity for purposes of transmitting and/or receiving energy according to the methods and systems described herein. For example, the artificially structured materials can include complementary metamaterial elements such as those presented in D. R. Smith et al, “Metamaterials for surfaces and waveguides,” U.S. Patent Application Publication No. 2010/0156573, and A. Bily et al, “Surface scattering antennas,” U.S. Patent Application Publication No. 2012/0194399, each of which is herein incorporated by reference. As another example, the artificially-structured materials can include patch elements such as those presented in A. Bily et al, “Surface scattering antenna improvements,” U.S. patent application Ser. No. 13/838,934, which is herein incorporated by reference.

Further, the artificially-structured materials, as described herein, can form, at least in part, metamaterial surface antennas. Metamaterial surface antennas, also known as surface scattering antennas, are described, for example, in U.S. Patent Application Publication No. 2012/0194399 (hereinafter “Bily I”). Surface scattering antennas that include a waveguide coupled to a plurality of subwavelength patch elements are described in U.S. Patent Application Publication No. 2014/0266946 (hereinafter “Bily II”). Surface scattering antennas that include a waveguide coupled to adjustable scattering elements loaded with lumped/active devices are described in U.S. Application Publication No. 2015/0318618 (hereinafter “Chen I”). Surface scattering antennas that feature a curved surface are described in U.S. Patent Application Publication No. 2015/0318620 (hereinafter “Black I”). Surface scattering antennas that include a waveguide coupled to a plurality of adjustably-loaded slots are described in U.S. Patent Application Publication No. 2015/0380828 (hereinafter “Black II”). And various holographic modulation pattern approaches for surface scattering antennas are described in U.S. Patent Application Publication No. 2015/0372389 (hereinafter “Chen II”). All of these patent applications are herein incorporated by reference in their entirety.

According to various embodiments, an apparatus for performing through medium imaging can include one or more radiating elements comprising one or more artificially-structured materials. The one or more radiating elements can be configured to transmit a radiation pattern of electromagnetic energy into a medium. The apparatus also can include one or more receiving elements configured to receive backscattered energy from the radiation pattern of electromagnetic energy transmitted into the medium. The backscattered energy received by the one or more receiving elements can be used to generate one or more through images of the medium.

In various embodiments, a method for performing through medium imaging comprises transmitting, using one or more radiating elements of an apparatus, a radiation pattern of electromagnetic energy into a medium as the apparatus remains static. The one or more radiating elements can comprise one or more artificially-structured materials. The method can also include receiving, using one or more receiving elements of the apparatus, backscattered energy from the radiation pattern of electromagnetic energy transmitted into the medium. The backscattered energy can be used to generate one or more through images of the medium as the apparatus remains static.

In certain embodiments, a method for performing through medium imaging comprises transmitting, using one or more radiating elements of an apparatus, a radiation pattern of electromagnetic energy into a medium as the apparatus is moved in relation to the medium. The one or more radiating elements can comprise one or more artificially-structured materials. The method can also include receiving, using one or more receiving elements of the apparatus, backscattered energy from the radiation pattern of electromagnetic energy transmitted into the medium. The backscattered energy can be used to generate one or more through images of the medium as the apparatus is moved in relation to the medium.

In various embodiments, blind deconvolution can be applied to generate one or more through images of a medium. The blind deconvolution can be applied to generate the images from backscattered energy received at one or more receiving elements from the medium in response to a radiation pattern of electromagnetic energy transmitted into the medium. The radiation pattern of electromagnetic energy can be transmitted into the medium from one or more radiating elements comprising one or more artificially-structured materials. Both the receiving elements and the radiating elements can be integrated as part of an apparatus.

In certain embodiments, a through medium imaging system comprises a processor and a computer-readable medium providing instructions accessible to the processor. The instructions can cause the processor to perform operations for generating one or more through images of a medium. Specifically, the instruction can cause the processor to apply blind deconvolution to generate one or more through images of the medium from backscattered energy received at one or more receiving elements. The backscattered energy can be received from the medium in response to a radiation pattern of electromagnetic energy transmitted into the medium from one or more radiating elements comprising one or more artificially-structured materials. Both the receiving elements and the radiating elements can be integrated as part of an apparatus.

Some of the infrastructure that can be used with embodiments disclosed herein is already available, such as general-purpose computers, computer programming tools and techniques, digital storage media, and communications networks. A computing device may include a processor such as a microprocessor, microcontroller, logic circuitry, or the like. The processor may include a special purpose processing device such as an ASIC, PAL, PLA, PLD, FPGA, or other customized or programmable device. The computing device may also include a computer-readable storage device such as non-volatile memory, static RAM, dynamic RAM, ROM, CD-ROM, disk, tape, magnetic, optical, flash memory, or other computer-readable storage medium.

Various aspects of certain embodiments may be implemented using hardware, software, firmware, or a combination thereof. As used herein, a software module or component may include any type of computer instruction or computer executable code located within or on a computer-readable storage medium. A software module may, for instance, comprise one or more physical or logical blocks of computer instructions, which may be organized as a routine, program, object, component, data structure, etc., that performs one or more tasks or implements particular abstract data types.

In certain embodiments, a particular software module may comprise disparate instructions stored in different locations of a computer-readable storage medium, which together implement the described functionality of the module. Indeed, a module may comprise a single instruction or many instructions, and may be distributed over several different code segments, among different programs, and across several computer-readable storage media. Some embodiments may be practiced in a distributed computing environment where tasks are performed by a remote processing device linked through a communications network.

The embodiments of the disclosure will be best understood by reference to the drawings, wherein like parts are designated by like numerals throughout. The components of the disclosed embodiments, as generally described and illustrated in the figures herein, could be arranged and designed in a wide variety of different configurations. Furthermore, the features, structures, and operations associated with one embodiment may be applicable to or combined with the features, structures, or operations described in conjunction with another embodiment. In other instances, well-known structures, materials, or operations are not shown or described in detail to avoid obscuring aspects of this disclosure.

Thus, the following detailed description of the embodiments of the systems and methods of the disclosure is not intended to limit the scope of the disclosure, as claimed, but is merely representative of possible embodiments. In addition, the steps of a method do not necessarily need to be executed in any specific order, or even sequentially, nor need the steps be executed only once.

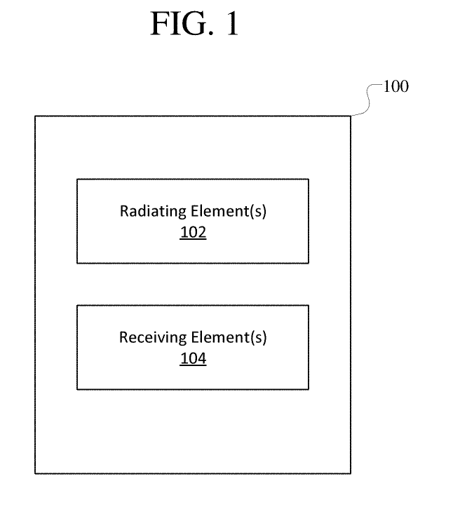

FIG. 1 illustrates an example imaging apparatus 100 for imaging through media. While the imaging apparatus 100 is shown as a single contained device, in certain embodiments, the imaging apparatus 100 can be implemented through multiple devices and systems that are separate, and potentially operate concurrently. Alternatively the imaging apparatus 100 can be implemented entirely at the single contained device. For example, processing to create through images of a medium can be performed at the single contained device, which is shown as representing the imaging apparatus 100 in FIG. 1. Alternatively, processing to create through images of a medium can be performed at a computing system remote from the single contained device, which is shown as representing the imaging apparatus 100 in FIG. 1.

A medium, as used herein, can include a medium with multiple layers of atoms, molecules, and/or materials that form the medium. Specifically, a medium can be formed by layers of the same material. For example, a medium can be a sheet of wood. Alternatively, a medium can be formed by multiple layers of different materials, e.g. a layered medium. For example, a medium can be a wall formed by both plywood and drywall. Further, a medium can be formed by a plurality of different mediums. For example, a medium can be formed by a plurality of walls, e.g. positioned next to each other.

Further, a medium can include one or more flat surfaces upon which the imaging apparatus 100 can be positioned in a stationary manner. Specifically, a medium can include a flat surface upon which the imaging apparatus 100 can be positioned and left unmoved for purposes of generating a through image of the medium. Alternatively, a medium can include one or more flat surface upon which the imaging apparatus 100 can be positioned and moved. Specifically, a medium can include a flat surface that the imaging apparatus 100 can be positioned and moved on for purposes of generating a through image of the medium.

A through image of a medium, as used herein, can include an image within the medium. For example, if a medium is a wall, then a through image for the wall can include an image of pipes within the wall. This can be useful for quickly detecting leaks in pipes within a wall. Further, a through image of a medium, as used herein, can include an image that is beyond the medium. For example, if a person is positioned on a second side opposite of a first side of a wall where an image is taken, then a through image can include an image of the person positioned proximate to the second side of the wall. Further in the example, the through image can be taken from the first side of the wall through the wall. Additionally, a through image of a medium, as used herein, can include an image both within the medium and beyond the medium. For example, a through image can include an image of objects within a wall and people on an opposing side of the wall from a radiation source used to obtain the image, e.g. using the imaging apparatus 100.

Further, a through image of a medium can be in one-dimensional space with respect to the medium. In particular, a through image of a medium can be an image along a single line with respect to the medium. Specifically, a through image of a medium can be an image of objects within the medium along a single line through the medium. For example, a through image of a medium can be an image of objects within the medium along a line corresponding to a line at which electromagnetic energy is transmitted into the medium. Further, a through image of a medium can be an image of objects beyond the medium along a single line beyond the medium. For example, a through image of a medium can be an image of objects beyond the medium along a single line corresponding to a line at which electromagnetic energy is transmitted into the medium. Additionally, a through image of a medium can be an image of objects both within the medium and outside of the medium along a line with respect to the medium. For example, a through image of a medium can be an image of objects within and beyond a medium along a line corresponding to a line at which electromagnetic energy is transmitted into the medium.

Additionally, a through image of a medium can be in two-dimensional space with respect to the medium. In particular, a through image of a medium can be an image in a plane with respect to the medium. Specifically, a through image of a medium can be an image of objects within the medium in a single plane through the medium. For example, a through image of a medium can be an image of objects within the medium in a single plane corresponding to a plane at which electromagnetic energy is transmitted into the medium. Further, a through image of a medium can be an image of objects beyond the medium in a single plane beyond the medium. For example, a through image of a medium can be an image of objects beyond the medium in a single plane corresponding to a plane at which electromagnetic energy is transmitted into the medium. Additionally, a through image of a medium can be an image of objects both within the medium and outside of the medium within a plane with respect to the medium. For example, a through image of a medium can be an image of objects within and beyond a medium within a plane corresponding to a plane at which electromagnetic energy is transmitted into the medium.

Furthermore, a through image of a medium can be a three-dimensional space image of the medium. In particular, a through image of a medium can be an image in three-dimensional space with respect to the medium. Specifically, a through image of a medium can be an image of objects within the medium in three-dimensional space through the medium. For example, a through image of a medium can be an image of objects within the medium in three-dimensional space within the medium corresponding to a plane at which electromagnetic energy is transmitted into the medium. Further, a through image of a medium can be an image of objects beyond the medium in three-dimensional space beyond the medium. For example, a through image of a medium can be an image of objects beyond the medium in three-dimensional space beyond the medium corresponding to a plane at which electromagnetic energy is transmitted into the medium. Additionally, a through image of a medium can be an image of objects both within the medium and outside of the medium within three-dimensional space with respect to the medium. For example, a through image of a medium can be an image of objects within and beyond a medium in three-dimensional space within and beyond the medium corresponding to a plane at which electromagnetic energy is transmitted into the medium.

The example imaging apparatus 100 shown in FIG. 1 includes one or more radiating elements 102, herein referred to as “radiating elements 102.” The radiating elements 102 function to transmit electromagnetic energy into, and potentially through, a medium for purposes of generating through images of the medium. Specifically, the radiating elements 102 can transmit a radiation pattern of electromagnetic energy into a medium. Subsequently and as will be discussed in greater detail later, through images of the medium can be generated based on backscattered energy from the electromagnetic energy transmitted into the medium by the radiating elements 102. For example, a through image of an object in a wall can be generated based on energy backscattered by the object in the wall from electromagnetic energy transmitted into the wall by the radiating elements 102. In another example, a through image of a person behind a wall can be generated based on energy backscattered by the person from electromagnetic energy transmitted into the wall by the radiating elements 102. Further in the example, the energy that is backscattered by the person can travel back through the wall towards the radiating elements 102, where it is subsequently used to generate a through image including the person.

The radiating elements 102 can include one or more artificially-structured materials. As discussed previously, the one or more artificially-structured materials can be formed by one or more subwavelength elements. Further and as discussed previously, the one or more artificially-structured materials can be formed by one or more metamaterials. For example, the radiating elements 102 can be formed by one or more dynamic metasurface antennas, herein referred to as “DMAs.”

Further the radiating elements 102 can be adjustable to transmit one or more variable radiation patterns of electromagnetic energy transmitted by the radiating elements 102. Specifically, the radiating elements 102 can be adjustable to adjust one or a combination of diffraction of, refraction of, and scattering of electromagnetic energy to change, or otherwise achieve, a specific radiation pattern of electromagnetic energy transmitted by the radiating elements 102. More specifically, the radiating elements 102 can be adjustable to adjust either or both a phase and a magnitude of transmitted waves of electromagnetic energy to achieve a specific radiation pattern of electromagnetic energy transmitted by the radiating elements 102.

In being adjustable to transmit one or more variable radiation patterns of electromagnetic energy, electrical/magnetic characteristics of the radiating elements 102 can be adjusted to transmit a specific radiation pattern of the one or more variable radiation patterns. Specifically, electrical impedances of the radiating elements 102 can be adjusted to change one or more feed waves to transmit a selected or otherwise target radiation pattern of electromagnetic energy from the one or more feed waves. Electrical impedances of the radiating elements 102 can be adjusted using an applicable mechanism. For example, electrical impedances of the radiating elements 102 can be adjusted by varying one or a combination of voltages, electric fields, electric currents, and magnetic fields applied to the radiating elements 102.

Further, in being adjustable to transmit one or more variable radiation patterns of electromagnetic energy, physical characteristics of the radiating elements 102 can be adjusted to transmit a specific radiation pattern of the one or more variable radiation patterns. Specifically, physical positions of the radiating elements 102 can be adjusted to change one or more feed waves to transmit a selected or otherwise target radiation pattern of electromagnetic energy from the one or more feed waves. More specifically, physical positions of the radiating elements 102, with respect to each other, can be adjusted to change one or more feed waves to transmit a selected radiation pattern of electromagnetic energy from the one or more feed waves. For example, a radiating element of the radiating elements 102 can be moved towards another radiating element of the radiating elements 102, in order to transmit a target radiation pattern of a variable radiation pattern. Further, orientations of the radiating elements 102 can be adjusted to change one or more feed waves to transmit a selected or otherwise target radiation pattern of electromagnetic energy from the one or more feed waves. More specifically, orientations of the radiating elements 102, with respect to each other, can be adjusted to change one or more feed waves to transmit a selected or otherwise target radiation pattern of electromagnetic energy from the one or more feed waves. For example, a first radiating element can be turned 25° with respect to another radiating element of the radiating elements 102, in order to transmit a target radiation pattern of a variable radiation pattern.

The example imaging apparatus 100 shown in FIG. 1 includes one or more receiving elements, herein referred to as “receiving elements 104.” The receiving elements 104 function to receive backscattered electromagnetic energy for purposes of generating through images of the medium. Specifically, the receiving elements 104 can receive backscattered energy from a radiation pattern of electromagnetic energy transmitted into, and potentially through, a medium by the radiating elements 102. For example, a through image of an object in a wall can be generated based on energy that is backscattered by an object in a wall and received by the receiving elements 104. In another example, a through image of a person behind a wall can be generated based on energy backscattered by the person and received by the receiving elements 104. Further in the example, the energy that is backscattered by the person can travel back through the wall towards the receiving elements 104, where it is subsequently received and used to generate a through image including the person.

The receiving elements 104 can include one or more artificially-structured materials. As discussed previously, the one or more artificially-structured materials can be formed by one or more subwavelength elements. Further and as discussed previously, the one or more artificially-structured materials can be formed by one or more metamaterials. For example, the receiving elements 104 can be formed by one or more DMAs.

Further the receiving elements 104 can be adjustable to receive backscattered energy from one or more variable radiation patterns of electromagnetic energy transmitted by the radiating elements 102. Specifically, the receiving elements 104 can be adjustable to receive backscattered energy from electromagnetic energy tuned to change one or a combination of diffraction of, refraction of, and scattering of the electromagnetic energy transmitted by the radiating elements 102. More specifically, the receiving elements 104 can be adjustable to receive backscattered energy from electromagnetic energy transmitted with either or both an adjusted phase and an adjusted magnitude by the radiating elements 102.

In being adjustable to receive backscattered energy from one or more variable radiation patterns of electromagnetic energy, electrical/magnetic characteristics of the receiving elements 104 can be adjusted to receive the backscattered energy from a specific radiation pattern of one or more variable radiation patterns. Specifically, electrical impedances of the receiving elements 104 can be adjusted for receiving backscattered energy from a variable radiation pattern transmitted by the radiating elements 102. Electrical impedances of the receiving elements 104 can be adjusted using an applicable mechanism. For example, electrical impedances of the receiving elements 104 can be adjusted by varying one or a combination of voltages, electric fields, electric currents, and magnetic fields applied to the receiving elements 104.

Further, in being adjustable to receive backscattered energy of one or more variable radiation patterns of electromagnetic energy, physical characteristics of the receiving elements 104 can be adjusted to receive the backscattered energy from a specific radiation pattern of the one or more variable radiation patterns. Specifically, physical positions of the receiving elements 104 can be adjusted to receive backscattered energy of a selected or otherwise target radiation pattern of electromagnetic energy generated from one or more feed waves. More specifically, physical positions of the receiving elements 104, with respect to each other, can be adjusted to receive backscattered energy of a selected radiation pattern of electromagnetic energy from one or more feed waves. For example, a receiving element of the receiving elements 104 can be moved towards another receiving element of the receiving elements 104, in order to receive backscattered energy from a target radiation pattern of a variable radiation pattern. Further, orientations of the receiving elements 104 can be adjusted to receive backscattered energy of a selected or otherwise target radiation pattern of electromagnetic energy from one or more feed waves. More specifically, orientations of the receiving elements 104, with respect to each other, can be adjusted to receive backscattered energy of a selected or otherwise target radiation pattern of electromagnetic energy generated from one or more feed waves. For example, a first receiving element can be turned 25° with respect to another receiving element of the receiving elements 104, in order to receive backscattered energy from a target radiation pattern of a variable radiation pattern transmitted by the radiating elements 102.

Either or both the radiating elements 102 and the receiving elements 104 can be formed by one or more transceivers. Further, the radiating elements 102 and the receiving elements 104 can be formed by the same element. For example, a transceiver can transmit electromagnetic energy in a desired radiation pattern for generating through images of a medium. Further in the example, the transceiver can receive backscattered energy from the transmitted electromagnetic energy for generating the through images of the medium.

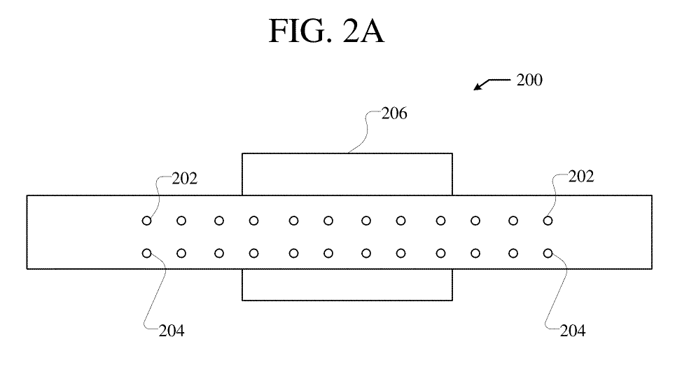

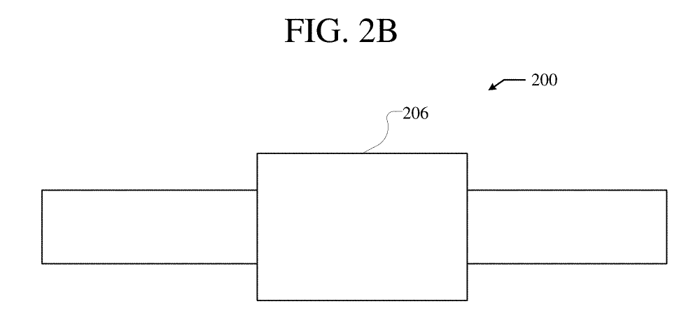

The radiating elements 102 and the receiving elements 104 can be formed by a single element, e.g. a single transceiver. Alternatively, the radiating elements 102 and the receiving elements 104 can be formed by a plurality of separate elements. Specifically, FIG. 2A shows a front view of an example imaging apparatus 200 with a plurality of separate elements that form radiating elements and receiving elements. FIG. 2B shows a back view of the example imaging apparatus 200. The imaging apparatus 200 shown in FIGS. 2A and 2B can function according to an applicable apparatus for generating through images of media, such as the imaging apparatus 100 shown in FIG. 1.

The example imaging apparatus 200 includes a plurality of radiating elements 202 and a plurality of receiving elements 204. In the example imaging apparatus 200, the radiating elements 202 are arranged along a first line, e.g. a dedicated radiator line, and the receiving elements 204 are arranged along a second line, e.g. a dedicated receiver line. In various embodiments, the radiating elements 202 and the receiving elements 204 can be dispersed within a plane. For example, the radiating elements 202 and the receiving elements 204 can be dispersed at alternating positions within a plane. Further, in various embodiments, the radiating elements 202 and the receiving elements 204 can be dispersed together within a single line or multiple lines. For example, the radiating elements 202 and the receiving elements 204 can be dispersed at alternating positions in a single line or multiple lines.

Further, the example imaging apparatus 200 includes a display 206. The display 206 can be integrated or coupled to circuitry and processing systems for generating through images of a medium from backscattered energy received by the receiving elements 204. Specifically, the display 206 can display through images of a medium generated using backscattered energy from an electromagnetic energy radiation pattern transmitted by the radiating elements 202. In being integrated within the imaging apparatus 200, the display 206 can present one or more through images to a user as they operate the imaging apparatus 200 to generate through images of a medium. For example, as will be discussed in greater detail later, a user can move the imaging apparatus 200 to generate one or more through images which are displayed on the display 206 as the user moves the imaging apparatus 200.

The display 206 can be removable from the imaging apparatus 200. Further, the display 206 can be a personal device of a user of the imaging apparatus 200. For example, the display 206 can be a smart phone of a user. Further, processing of backscattered energy to create through images can be performed remote from the display 206. For example, through images can be created remote from the display, e.g. in a remote network environment, and subsequently transmitted to the display 206 for presentation to a user of the imaging apparatus 200.

The example imaging apparatus 200 can also include manipulation mechanisms that allow a user to control or otherwise physically manipulate the imaging apparatus 200. For example, the imaging apparatus 200 can include handles that extend out from the back side of the imaging apparatus 200. Accordingly, a user can grip the handles to place the imaging apparatus 200 on a surface of a medium in order to generate through images of the medium. Further, the user can use the handles to move the imaging apparatus 200 along the surface of the medium in order to generate through images of the medium.

Returning back to the example imaging apparatus 100 shown in FIG. 1, the receiving elements 104 can receive backscattered energy for generating a one-dimensional through image. Specifically, the receiving elements 104 can receive backscattered energy from an electromagnetic energy radiation pattern transmitted by the radiating elements 102 for generating a one-dimensional through image of a medium. The one-dimensional through image can be formed along a line in either or both the medium and space beyond the medium. For example, a one-dimensional through image generated from backscattered energy received by the receiving elements 104 can include both a portion of a medium and an object behind the medium, e.g. an opposite side of the medium from where the imaging apparatus 100 is positioned.

Further, the receiving elements 104 can receive backscattered energy for generating a two-dimensional through image. Specifically, the receiving elements 104 can receive backscattered energy from an electromagnetic energy radiation pattern transmitted by the radiating elements 102 for generating a two-dimensional through image of a medium. The two-dimensional through image can be formed along a plane in either or both the medium and space beyond the medium. For example, a two-dimensional through image generated from backscattered energy received by the receiving elements 104 can include both a portion of a medium and an object behind the medium.

In generating a two-dimensional through image, the radiating elements 102 and the receiving elements 104 can be arranged in a plane or in a line. Specifically, when the radiating elements 102 and the receiving elements 104 are arranged in a line to create a two-dimensional through image, the imaging apparatus 100 can be moved along a medium to generate the through image. Alternatively, when the radiating elements and the receiving elements 104 are arranged in a plane, the imaging apparatus 100 can either be kept stationary or moved to generate one or more two-dimensional through images. For example, the imaging apparatus 100 can be kept stationary and a two-dimensional image can be created within an aperture field of view created by the radiating elements 102 and the receiving elements 104 within the field of view. Alternatively, the imaging apparatus 100 can be moved along a medium to extend the aperture field of view, or otherwise increase the size of the aperture, created by the radiating elements 102 and the receiving elements 104 along the medium. This is applicable when the radiating elements 102 and the receiving elements 104 are arranged in a single line and also when the radiating elements 102 and the receiving elements 104 are arranged in a plane. In turn, a two-dimensional image can be created based on the extended aperture field of view created by moving the imaging apparatus 100 along the medium.

By moving the imaging apparatus 100 to extend the aperture field of view, a synthetic aperture is created and through imaging can be performed using the synthetic aperture, e.g. through synthetic aperture radar, herein referred to as “SAR.” The synthetic aperture has an increased size, e.g. electrical size, compared to the actual aperture created by the radiating elements 102 and the receiving elements 104. In turn, this creates a synthetic aperture field of view greater than an actual aperture field of view created by the radiating elements 102 and the receiving elements 104. This can allow for larger through images and also increased imaging apparatus 100 resolution. Further, this can reduce the number of radiating elements 102 and receiving elements 104 needed to perform through media imaging. Potentially, only a single transducer is needed to perform through media imaging.

Additionally, the receiving elements can receive backscattered energy for generating a three-dimensional through image. Specifically, the receiving elements 104 can receive backscattered energy from an electromagnetic energy radiation pattern transmitted by the radiating elements 102 for generating a three-dimensional through image of a medium. The three-dimensional through image can be formed in space in either or both the medium and beyond the medium. For example, a three-dimensional through image generated from backscattered energy received by the receiving elements 104 can include both a portion of a medium and an object behind the medium in space within the medium and beyond the medium.

In generating a three-dimensional through image, the radiating elements 102 and the receiving elements 104 can be arranged in a plane or in a line. Specifically, when the radiating elements 102 and the receiving elements 104 are arranged in a line to create a three-dimensional through image, the imaging apparatus 100 can be moved along a medium to generate the through image. Alternatively, when the radiating elements and the receiving elements 104 are arranged in a plane, the imaging apparatus 100 can either be kept stationary or moved to generate one or more three-dimensional through images. For example, the imaging apparatus 100 can be kept stationary and a three-dimensional image can be created within an aperture field of view created by the radiating elements 102 and the receiving elements 104 within the field of view. Alternatively, the imaging apparatus 100 can be moved along a medium to extend the aperture field of view created by the radiating elements 102 and the receiving elements 104 along the medium. This is applicable when the radiating elements 102 and the receiving elements 104 are arranged in a single line and also when the radiating elements 102 and the receiving elements 104 are arranged in a plane. In turn, a three-dimensional image can be created based on the extended radiation pattern field of view created by moving the imaging apparatus 100 along the medium.

The imaging apparatus 100 can be configured to create a plurality of through images, e.g. two-dimensional and three-dimensional through images, of a medium independent from each other. Specifically, the imaging apparatus 100 can be configured to create a plurality of independent through images of a medium as the imaging apparatus 100 is moved. Independent through images can be stitched together to form through images. For example, a plurality of three-dimensional through images can be stitched together to form a larger three-dimensional through image. In another example, a plurality of two-dimensional through images can be stitched to form a three dimensional through image.

The imaging apparatus 100 can include circuitry and computing systems for generating through images using backscattered energy received by the receiving elements 104. The through images can be generated using an applicable technique for generating through images based on backscattered energy, such as the techniques and methods described herein. For example, as will be discussed in greater detail later, through images of a medium can be generated absent knowledge of the characteristics of the medium, e.g. using blind deconvolution.

Through images can be generated by the imaging apparatus 100 based on operational characteristics of either or both the radiating elements 102 and the receiving elements 104. Operational characteristics include applicable characteristics of the radiating elements 102 operating to transmit a radiation pattern of electromagnetic energy and the receiving elements 104 operating to receive backscattered energy from a transmitted radiation pattern of electromagnetic energy. For example, operational characteristics can include characteristics of a radiation pattern transmitted by the radiating elements 102 and electrical and physical characteristics of the radiating elements 102 in transmitting the radiation pattern. In another example, operational characteristics can include characteristics of backscattered energy received by the receiving elements 104 and electrical and physical characteristics of the receiving elements 104 in receiving the backscattered energy.

Further, the imaging apparatus 100 can generate through images based on positions of the radiating elements 102 and the receiving elements 104. In particular, the imaging apparatus 100 can generate through images based on positions of the radiating elements 102 and the receiving elements 104 within the imaging apparatus 100 with respect to a medium being imaged. For example through images of a medium can be generated based on positions of the radiating elements 102 and the receiving elements as the imaging apparatus 100 is moved on one or more surfaces of the medium.

Positions of the radiating elements 102 and the receiving elements 104 can be identified based on a tracked position of the imaging apparatus 100, e.g. as the imaging apparatus is moved with respect to a medium being imaged. The tracked position of the imaging apparatus 100, in turn, can be used to generate through images as the imaging apparatus 100 is moved. In particular, the measured characteristics of the radiating elements 102 and the receiving elements 104 at different spatial locations can be linked based on tracked position of the imaging apparatus 100 corresponding to the different spatial locations of the radiating elements 102 and the receiving elements 104. For example, if a radiating element is moved from a first location to a second location, as indicated by a tracked position of the imaging apparatus 100, then the tracked position can be used to determine the characteristics of the radiating element at the first location and the second location. In turn, the characteristics of the radiating element at the locations, as identified based on the tracked position, can be used to create one or more through images. Further, the characteristics of the radiating elements, as discussed previously, can be used to stitch together through images.

A position of the imaging apparatus 100 can be tracked using an applicable position tracking mechanism. In particular, a position of the imaging apparatus 100 can be tracked using mechanical tracking elements, e.g. included as part of the imaging apparatus 100. For example, a position of the imaging apparatus 100 can be tracked based on a changed position and/or orientation of a mechanical element integrated as part of the imaging apparatus 100 in response to movement of the imaging apparatus 100. Further, a position of the imaging apparatus 100 can be tracked using electrical tracking elements, e.g. included as part of the imaging apparatus 100. For example, a position of the imaging apparatus 100 can be tracked using a global positioning system, herein referred to as “GPS,” sensor integrated as part of the imaging apparatus 100. Additionally, a position of the imaging apparatus 100 can be tracked using optical tracking elements, e.g. included as part of the imaging apparatus 100. For example, a position of the imaging apparatus 100 can be tracked using an optical position sensor integrated as part of the imaging apparatus 100.

Operational characteristics of the radiating elements 102 and the receiving elements 104 can be measured simultaneously by the imaging apparatus. While all of the elements are measured simultaneously, the imaging apparatus can perform pre-processing to form through images. The pre-processing allows the contribution of each element (to the overall signal) to be determined separately. This means that each radiating element and/or receiving element associated with a single feed can be treated, in processing, as being composed of many smaller, independently-tuned elements. In this sense, the imaging apparatus 100 can be treated as a virtual multiple-input multiple-output, herein referred to as “MIMO” system, e.g. as the elements include artificially-structured materials. Specifically, the imaging apparatus 100 can be characterized and processed as a virtual MIMO according to applicable techniques, such as those described in T. Sleasman et al., “Design considerations for a dynamic metamaterial aperture for computational imaging at microwave frequencies,” J. Opt. Soc. Am. B 33, 1098-1111 (2016) and T. Sleasman et al, “Single-frequency microwave imaging with dynamic metasurface apertures,” J. Opt. Soc. Am. B 34, 1713-1726 (2017), each of which is herein incorporated by reference.

Once the imaging apparatus 100 has been represented as a virtual MIMO system, the contributions of the obscuring material can be taken into consideration by the imaging apparatus 100 in order to generate through images. This can be done by analytically propagating the fields through the obscuring material. If the obscuring materials' properties are known, such as with drywall in houses, analytic propagation is easily completed. More complicated materials may require additional characterization or a preprocessing calibration step before the imaging apparatus 100 can be used for imaging. The material parameters may also be estimated in conjunction with the scene estimation. Signal compensation can be completed for the waveforms that transmit and/or reflect from the obscuring structures. Taking into account all of these contributions enhances the image fidelity and allows for a complete picture of the scene. Once the contributions of the obscuring materials are compensated for in processing, the imaging apparatus 100 can reconstruct through images from backscattered energy through a variety of reconstruction methods such as the range migration algorithm (RMA).

The imaging apparatus 100 can be configured to operate at a specific operational frequency. Specifically, the imaging apparatus 100 can be configured to operate at an operational frequency of feed waves used to transmit the electromagnetic radiation pattern. An operational frequency of the imaging apparatus 100 can include frequencies in the microwave frequency range and the radio frequency range.

The imaging apparatus 100 can be configured to operate using feed waves at a single frequency. Alternatively the imaging apparatus 100 can be configured to operate using feed waves within a narrow frequency band with respect to an operating frequency of the imaging apparatus 100. For example, the imaging apparatus 100 can be configured to operate using feed waves within 1% of an operating frequency of the imaging apparatus 100. Further, the imaging apparatus 100 can be configured to operate using feed waves within a broad frequency band with respect to an operating frequency of the imaging apparatus 100. For example, the imaging apparatus 100 can be configured to operate using feed waves greater than 1% of an operating frequency of the imaging apparatus 100.

Since artificially-structured materials can be electrically-large and can act in a virtual MIMO manner, they have the ability to obtain range information without using frequency bandwidth. Therefore, and as discussed in the previous paragraph, the imaging apparatus 100 can utilize some or no bandwidth at all to generate through images. If no bandwidth is used (e.g. single-frequency operation) the imaging apparatus 100 will be less sensitive to material dispersion and calibration. Specifically, the radiating elements 102 can transmit different radiation patterns using feed waves at a single frequency. More specifically, characteristics of the radiating elements 102 can be changed to adjust transmitted radiation patterns using feed waves at a single frequency. This allows for through imaging of a medium absent knowledge of characteristics of the medium. In particular, single frequency imaging becomes important in practice when one wants to move the imaging apparatus 100 to synthesize a large aperture; a process that can cause misalignment and degrade calibration. Combining these advantages, the imaging apparatus 100, as described previously, can thus be composed of a single transmitter, a single receiver, and a narrowband energy source. This makes the physical hardware cost-effective and simple. Further, since artificially-structured materials can be fabricated on printed circuit boards, the imaging apparatus 100 can be easily produced and have a flat form factor.

The imaging apparatus 100 can include a feed structure coupled to the radiating elements 102 and potentially coupled to the receiving elements 104. The feed structure can be configured to provide one or more feed waves to the radiating elements 102. The radiating elements 102 can use the feed waves provided by the feed structure to transmit a radiation pattern of electromagnetic energy for performing through imaging. In being coupled to the feed structure, either or both the radiating elements 102 and the receiving elements 104 can be positioned on top of the feed structure.

The feed structure can include a waveguide. A waveguide included as part of the feed structure can be a one-dimensional waveguide or a two-dimensional waveguide. For example, the feed structure can include parallel plates that form a two-dimensional waveguide. Additionally, the feed structure can include a cavity. A cavity can be formed by an enclosed, at least in part, waveguide. For example, a cavity can be formed by parallel plates surrounded, at least in two dimensions, by a terminal. In another example a cavity can be formed by a tubular waveguide with plugged or otherwise enclosed ends.

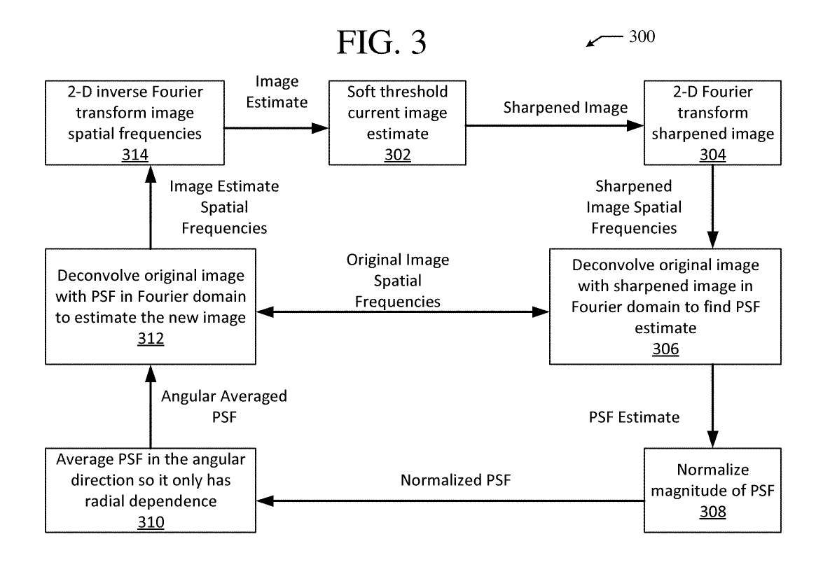

FIG. 3 is a flowchart 300 of an example method of generating through images of a medium based on energy backscattered from one or more electromagnetic radiation patterns transmitted into the medium. The method can be used to generate through images of a layered medium. Further, the method can be implemented at an applicable imaging apparatus, such as the imaging apparatuses described here. For example, the method can be implemented using circuitry and computer systems of the imaging apparatus 100. Additionally, the method can be implemented using an applicable imaging apparatus, such as the imaging apparatuses described herein. For example, the method can be implemented based on backscattered energy received by the receiving elements 104 from radiation patterns transmitted by the radiating elements 102.

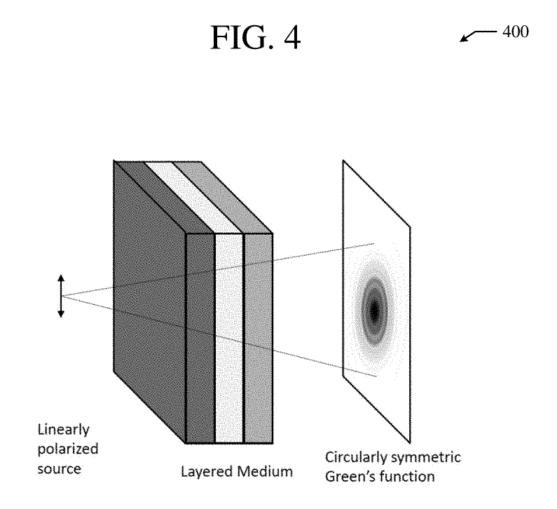

Before discussing the method shown in FIG. 3, a discussion of a Green's functions of a medium is first discussed. Specifically, FIG. 4 shows a representation 400 of a nearly circularly symmetric Green's function produced by a linearly polarized dipole through a medium. The excitation of a medium by a point source is calculated using the scattering matrix method and it is briefly summarized here. A point source is polarized along the plane of the layers as shown in FIG. 4 with a polarization state ε_{\hat{x}}x+ε_{ŷ}y. The field incident on the wall E_{inc} can be represented using the Weyl plane wave expansion of a point source by Equation 1.

$${E}_{inc} ( x ; y ) = \frac{{iE}_{0}}{2 π {k}_{0}} {\int }_{- ∞}^{∞} {\int }_{- ∞}^{∞} \frac{{dk}_{x} {dk}_{y}}{{k}_{z}} exp [ i ( {k}_{x} x + {k}_{y} y ) ] ( {ɛ}_{⊥} + {ɛ}_{\vert \vert} ) \\ {k}_{z} = \sqrt{{k}_{0}^{2} - {k}_{x}^{2} - {k}_{y}^{2}} \\ {ɛ}_{⊥} = \frac{( {ɛ}_{x} {k}_{y}^{2} - {ɛ}_{y} {k}_{x} {k}_{y} ) x + ( {ɛ}_{y} {k}_{x}^{2} - {ɛ}_{x} {k}_{x} {k}_{y} ) y}{{k}_{x}^{2} + {k}_{y}^{2}} \\ {ɛ}_{\vert \vert} = \frac{\begin{matrix}( {ɛ}_{x} {k}_{x}^{2} + {ɛ}_{y} {k}_{x} {k}_{y} ) {k}_{x}^{2} x + ( {ɛ}_{x} {k}_{x} {k}_{y} + {ɛ}_{y} {k}_{y}^{2} ) {k}_{z}^{2} y - \\ ( {ɛ}_{x} {k}_{x} + {ɛ}_{y} {k}_{y} ) {k}_{z} ( {k}_{x}^{2} + {k}_{y}^{2} ) z\end{matrix}}{{( {k}_{x} {k}_{z} )}^{2} + {( {k}_{y} {k}_{z} )}^{2} + {( {k}_{x}^{2} + {k}_{y}^{2} )}^{2}} \qquad ( 1 )$$

In Equation 1, the field has been expressed as a sum of the parallel to the plane of incidence ε_{∥} and the field perpendicular to it ε_{⊥′}. Assuming the medium before and after the layers is the same so that k₀ is the same, the transmitted field after the layers Eₜᵣₐₙₛ can be calculated by multiplying by the appropriate transmission coefficient shown in Equation 2.

$${E}_{trans} ( x ; y ) = \frac{{iE}_{0}}{2 π {k}_{0}} {\int }_{- ∞}^{∞} {\int }_{- ∞}^{∞} \frac{{dk}_{x} {dk}_{y}}{{k}_{z}} exp [ i ( {k}_{x} x + {k}_{y} y ) ] \\ ( {τ}_{⊥} ( {k}_{x} ; {k}_{y} ; {k}_{0} ) {ɛ}_{⊥} + {τ}_{\vert \vert} ( {k}_{x} ; {k}_{y} ; {k}_{0} ) {ɛ}_{\vert \vert} ) \qquad ( 2 )$$

To determine the transmission coefficients, the method of scattering matrices can be used. There are N layers with dielectric constants ε_{|} to ε_{N} each layer having a thicknesses d₁ to d_{N}. The impedance of each layer n is given by

$${Z}_{n}^{⊥} = \sqrt{\frac{{k}_{0}^{2} {ɛ}_{n}}{{k}_{0}^{2} {ɛ}_{n} - {k}_{x}^{2} - {k}_{y}^{2}}} \sqrt{\frac{{μ}_{0}}{{ɛ}_{0} {ɛ}_{n}}} or {Z}_{n}^{\vert \vert} = \sqrt{\frac{{k}_{0}^{2} {ɛ}_{n} - {k}_{x}^{2} - {k}_{y}^{2}}{{k}_{0}^{2} {ɛ}_{n}}} \sqrt{\frac{{μ}_{0}}{{ɛ}_{0} {ɛ}_{n}}} ,$$

depending on whether or not the polarization is parallel to or perpendicular to the plane of incidence. The transmission matrix of the entire stack of layers is given by Equation 3.

$$[ \begin{matrix}{T}_{11} {T}_{12} \\ {T}_{21} {T}_{22}\end{matrix} ] = {\prod }_{n = 1}^{N} \frac{{Z}_{n} + {Z}_{n + 1}}{2 {Z}_{n + 1}} [ \begin{matrix}exp ( {ik}_{n} {d}_{n} ) {Γ}_{n} exp ( - {lk}_{n} {d}_{n} ) \\ {Γ}_{n} exp ( {ik}_{n} {d}_{n} ) exp ( - {lk}_{n} {d}_{n} )\end{matrix} ] \\ {Γ}_{n} = ( {Z}_{n + 1} - {Z}_{n} ) \text{/} ( {Z}_{n + 1} + {Z}_{n} ) ; {Γ}_{N} = 0 \\ {k}_{n} = \sqrt{{k}_{0}^{2} {ɛ}_{n} - {k}_{x}^{2} - {k}_{y}^{2}} \qquad ( 3 )$$

The product of the matrices is right-to-left so that the layer closest to the source is applied first. The transmission coefficient is then given by τ(kₓ,k_{y},k₀)=T₁₁−T₁₂T₂₁/T₂₂.

Using Equation 2 with the appropriate transmission coefficients, the radiation produced by the point source transmitted through the dielectric stack may be calculated. However, for a backscatter imaging configuration, both the transmitted signal and the received signal use this radiation pattern. If the susceptibility of the target is given by a function χ(x,y), the measured backscattered power at the antenna is given by Equation 4

$$W ( {x}^{′} ; {y}^{′} ) = \frac{i 2 {π}^{2}}{{η}_{0} k} {\int }_{- ∞}^{∞} {\int }_{- ∞}^{∞} P ( x - {x}^{′} ; y - {y}^{′} ) χ ( x ; y ) dx dy \\ with P ( x ; y ) = {{E}_{trans} ( x ; y )}^{T} {E}_{trans} ( x ; y ) \qquad ( 4 )$$

with the dot product of the field with itself E^{T}E is a point spread function (PSF)P(x,y).

Returning back to the flowchart 300 shown in FIG. 3, the measured backscattered power is related to the object susceptibility through a convolution with a nearly circularly symmetric PSF. Because this PSF is not known a priori, the blind deconvolution method presented here attempts to infer the PSF from the data. We note that in the Fourier domain the convolution of Eq. 4 can be written as W(kₓ,k_{y})≅P(kₓ,k_{y})χ(kₓ,k_{y}) with ⁻W(kₓ,k_{y}), ⁻P(kₓ,k_{y}), and ⁻χ(kₓ,k_{y}) being the Fourier transforms of W(x,y), P(x,y), and x(x,y). If the PSF was known, then the PSF could be estimated using a Wiener filter. Likewise, if the object x(x,y) was known, the PSF could be estimated from the object using a Weiner filter as well. In the absence of any constraints, any two functions P(x,y) and x(x,y) that the relationship W(kₓ,k_{y})≅P(kₓ,k_{y})χ(kₓ,k_{y}) is a solution. However, if P(x,y) is circularly symmetric, then P(kₓ,k_{y}) is as well, so that plausible solutions for x(x,y) correspond to those that after deconvolving the data W(x,y) by x(x,y) produce a circular symmetric P(x,y). Other common constraints to the point-spread function, such as enforcing positivity, do not apply as the PSF is complex valued. There is still a space of one-dimensional functions P(x,y) that all produce plausible x(x,y) so additional constraints are needed.

A further ambiguity is that if the data is bandlimited, it is not discernible whether the object is bandlimited by convolution by the PSF, or if the object itself is bandlimited. The trivial example of this is to assume the PSF is a delta function and therefore χ(x,y)∝W(x,y). As many objects of interest are likely to have sharp edges or relatively few features, this may be used as a constraint. To enforce objects that have sharp edges, or few features, a sparsity constraint can be applied. A typical approach to constraining the sparsity is to minimize the [symbol] -norm of the function:

$${‖ χ ‖}_{1} = {\int }_{- ∞}^{∞} {\int }_{- ∞}^{∞} \vert χ ( x , y ) \vert dx dy \qquad ( 5 )$$

The [symbol] -norm is a convex approximation to the true [symbol] norm that is a count of the nonzero elements of a vector, and may be optimized using basis pursuit methods. Soft-thresholding increases the sparsity of a vector by decreasing the magnitudes of a vector by a fixed amount, setting the negative magnitudes to zero:

$${χ}_{T} ( x , y ) = \frac{\overline{χ} ( x , y )}{\vert χ ( x , y ) \vert} \frac{[ χ ( x , y ) - α ] + \vert [ χ ( \overline{x} , y ) - \overline{α} ] \vert}{2} \qquad ( 6 )$$

where is the soft-thresholded x(x,y), and a is an amount by which to decrease the magnitude. Specifically, χ_{T}(x,y)=0 for all values of x and y such that |χ(x,y)|<α, χ_{T}(x,y) is more sparse than x(x,y). As the soft-thresholding operation introduces edges into χ_{T}(x,y) where |χ(x,y)|<α, this tends to sharpen edges smoothed by blurring of the point spread function, concentrating the images of points towards the center of the points.

A further trivial constraint is that one may multiply x(x,y) by a constant and divide P(x,y) by the same constant to obtain another solution. To resolve this ambiguity, the [symbol] -norm of the PSF is normalized to one:

$${\int }_{- ∞}^{∞} {\int }_{- ∞}^{∞} {\vert P ( x , y ) \vert}^{2} dx dy = 1 \qquad ( 7 )$$

There are then three constraints of this blind deconvolution problem: that the PSF is circularly symmetric, that the object be sparse, and that the point spread function have unit [symbol] -norm. These are combined into the iterative method represented by the flowchart 300. The method begins with the original image data as given by W(x,y) and an initial estimate of the object χ⁽⁰⁾(x,y)=W(x,y). The cycle of the methods starts at step 302 of FIG. 3, with each step/block labeled with its step number, and the steps are as follows:

At step 302, the current image estimate χ⁽ⁿ⁾(x,y) is soft-thresholded to form a new image χ_{T}⁽ⁿ⁾(x,y) with reduced [symbol] -norm as given in Equation 7.

At step 304, the 2-D Fourier transform of χ_{T}⁽ⁿ⁾(x,y) is calculated to yield χ_{T}⁽ⁿ⁾(kₓ,k_{y}) as shown in Equation 8 below.

$${χ}_{T}^{( n )} ( {k}_{x} , {k}_{y} ) = {\int }_{- ∞}^{∞} {\int }_{- ∞}^{∞} {χ}_{T}^{( n )} ( x , y ) exp [ i ( {k}_{x} x + {k}_{y} y ) ] dx dy \qquad ( 8 )$$

At step 306, the Fourier transform of the PSF is estimated using the Weiner filter, which minimizes the squared error of the PSF with [symbol] regularization.

$${ }^{-} {P}^{( n )} ( {k}_{x} ; {k}_{y} ) = \frac{{}^{-} W ( {k}_{x} ; {k}_{y} ) {{χ}_{T}^{( n )} ( {k}_{x} ; {k}_{y} )}^{*}}{{\vert {}_{ }^{-}{χ}{}_{T}^{( n )} ( {k}_{x} ; {k}_{y} ) \vert}^{2} + λ {‖ {χ}_{T}^{( n )} ( {k}_{x} ; {k}_{y} ) ‖}_{2}^{2}} \\ {‖ {χ}_{T}^{( n )} ( {k}_{x} ; {k}_{y} ) ‖}_{2}^{2} = {\int }_{- ∞}^{∞} {\int }_{- ∞}^{∞} {\vert {}_{ }^{-}{χ}{}_{T}^{( n )} ( {k}_{x} ; {k}_{y} ) \vert}^{2} {dk}_{x} {dk}_{y} \qquad ( 9 )$$

The regularization constant λ is proportional to the [symbol] -norm of χ_{T}⁽ⁿ⁾(x,y) so that the PSF does not contain frequencies for which the object does not have sufficient magnitude.

At step 308, the [symbol] -norm of the PSF is normalized to one to enforce the condition of Equation 7.

$${P}^{′ ( n )} ( x , y ) = \frac{{P}^{( n )} ( x , y )}{{‖ {P}^{( n )} ‖}_{2}} \qquad ( 10 )$$

At step 310, to enforce that the PSF is circularly symmetric, it is averaged in the angular direction. Two angularly averaged functions are formed, with the circularly symmetric PSF being a combination of the two

$${P}_{M}^{( n )} ( r ) = {[ \frac{1}{2 π} {\int }_{- π}^{π} {\vert {P}^{′ ( n )} ( r cos Θ ; r sin Θ ) \vert}^{1 \text{/} 2} d Θ ]}^{2} \\ {P}_{φ}^{( n )} ( r ) = \frac{1}{2 π} {\int }_{- π}^{π} {P}^{′ ( n )} ( r cos Θ ; r sin Θ ) d Θ \\ {P}_{A}^{( n )} ( r ) = {P}_{M}^{( n )} ( r ) \frac{{P}_{φ}^{( n )} ( r )}{\vert {P}_{φ}^{( n )} ( r ) \vert} \qquad ( 11 )$$

P_{M}⁽ⁿ⁾(r) is the average of the magnitude of the PSF in the angular direction. The average is weighted so the smaller values of magnitude influence the average more by taking the square root of the magnitude. P_{M}⁽ⁿ⁾(r) is the simple average which is used to infer the phase. These two are combined together to find the angularly averaged PSF P_{A}⁽ⁿ⁾(r). If P_{ϕ}⁽ⁿ⁾(r) is used to infer both the magnitude and phase, the magnitude is often underestimated due to cancellation of phases.

At step 312, the Weiner filter is used to infer a new estimate of the object from the PSF, which minimizes the squared-error of the object with [symbol] regularization:

$${}_{ }^{-}{χ}{}_{ }^{( n + 1 )} ( {k}_{x} , {k}_{y} ) = \frac{{}^{-} W ( {k}_{x} , {k}_{y} ) {{P}_{A}^{( n )} ( {k}_{x} , {k}_{y} )}^{*}}{{\vert {}_{ }^{-}{P}{}_{A}^{( n )} ( {k}_{x} , {k}_{y} ) \vert}^{2} + λ} \qquad ( 12 )$$

At step 314, the inverse Fourier transform of χ⁽ⁿ⁺¹⁾(kₓ,k_{y}) is taken to obtain the object estimate χ⁽ⁿ⁺¹⁾(kₓ,k_{y}):

$${χ}^{( n + 1 )} ( x ; y ) = \frac{1}{{( 2 π )}^{2}} {\int }_{- ∞}^{∞} {\int }_{- ∞}^{∞} \sim {χ}^{( n + 1 )} ( {k}_{x} ; {k}_{y} ) exp [ - i ( {k}_{x} x + {k}_{y} y ) ] {dk}_{x} {dk}_{y} \qquad ( 13 )$$

The regularization constant λ is started at a larger value and is decreased as the iterations proceed. A small regularization constant λ is needed so that the method does not overly smooth the object and reject high frequencies, but also may sharpen spurious edges present from diffraction effects. A large regularization constant is effective but removes the high frequencies of the object. By starting with a high regularization constant the gross features are first identified and then sharpened as the regularization constant is decreased with each iteration of the method. Because the method is three successive minimization steps, a [symbol] minimization to increase the sparsity of the object, a squared-error minimization to find the PSF, and a second squared-error minimization to estimate the object, the order of operations can strongly determine the rate of convergence, and adjusting the regularization constant during the iterations is a convenient way to accelerate convergence. Because the original spatial frequency data is applied at both squared-error minimization steps, the reconstructed object remains consistent with the data.

### Example of Through Medium Imaging Using the Above-Described Method

To demonstrate through-wall imaging using the blind deconvolution method, a radar scanner was constructed consisting of two linearly polarized short dipole antennas 4 cm apart. These interrogated the object at frequencies between 17 and 26 GHz, however, only one frequency was used in the reconstructed image. A vector network analyzer transmitted 17 dBm of power from one dipole and sampled the power and relative phase of the backscattered signal at the other dipole. These two dipoles were placed on a two-axis translation stage and the backscattered signal sampled at 5 mm intervals over a rectangular area. While the system is translationally symmetric except for the object, the dipoles are separated slightly in the X-direction are linearly polarized, slightly breaking the circular symmetry of the point spread function. Nevertheless, satisfactory results were obtained.

Because one of the applications envisioned for TWI is the nondestructive imaging of the infrastructure inside the walls of buildings, the objects and layered media being tested are intended to be realistic examples for this application. Realistic walls, however, deviate from an ideal layered dielectric structure in several ways. Walls are not perfectly flat or planar, the layers may be skewed relative to each other, and most importantly, the materials are inhomogeneous. There can often be significant scattering from inside the layers as well as the object behind the layers, and the method may focus the internal scattering of the wall layers rather than the object. Some building materials have more internal scattering than others, for example, plywood has significant internal scattering, likely due to the alternating orientations of the plies, as opposed to gypsum plasterboard which tends to be more homogeneous.

For an ideal layered medium, the reflection from the layers would be the same at any translational position of the antennas relative to the layers, and so subtracting off the average reflected signal as a function of position would remove the reflection of the layers from the data. Because many realistic walls are of non-uniform thickness or spacing, the reflection from the wall slowly varies along the translation directions. Because this reflection signal is often much stronger than the object signal, the example method represented by the flowchart 300, focuses the reflections from the wall rather than the object behind the wall. To remove these reflections that slowly vary with position, a high-pass filter is applied to the data W(x,y) to find W_{H}(x,y):

$${}^{-} W ( {k}_{x} ; {k}_{y} ) = {\int }_{- ∞}^{∞} {\int }_{- ∞}^{∞} W ( x ; y ) exp [ i ( {k}_{x} x + {k}_{y} y ) ] dx dy \\ {}_{}^{-}{W}{}_{H}^{} ( {k}_{x} ; {k}_{y} ) {=}^{-} W ( {k}_{x} ; {k}_{y} ) [ 1 - exp ( - \frac{{h}^{2}}{2} [ {k}_{x}^{2} + {k}_{y}^{2} ] ) ] \\ {W}_{H} ( x ; y ) = \frac{1}{{( 2 π )}^{2}} {\int }_{- ∞}^{∞} {\int }_{- ∞}^{∞} {}_{}^{-}{W}{}_{H}^{} ( x ; y ) exp [ - i ( {k}_{x} x + {k}_{y} y ) ] {dk}_{x} {dk}_{y} \qquad ( 14 )$$

where h is the feature size above which the features should be removed. This high pass filtering is a generalization of subtracting off of the average that accounts for some wall thickness non-uniformity.

Because the data is taken only over a finite area, the function W(x,y) has finite support, and as the finite support is presented as hard edges in the data, the method is likely to form an image of the hard edges of the support rather than the edges of the object. It is necessary to taper the magnitude of W_{H}(x,y) towards the edge of its support to prevent this. To taper the function inside the support, if the support of W(x,y) is confined to −L_{X}/2≤x≤L_{X}/2 and −L_{Y}/2≤Y≤L_{Y}/2, the tapered version W_{T}(x,y) of W_{H}(x,y) is:

$${W}_{T} ( x , y ) = {W}_{H} ( x , y ) cos ( \frac{π x}{{L}_{χ}} ) cos ( \frac{π y}{{L}_{Y}} ) \qquad ( 15 )$$

Both the Gaussian filter of Equation 14 and the cosine window of Equation 15 were selected because these are smooth and therefore are unlikely to introduce ringing into the PSF or the image.

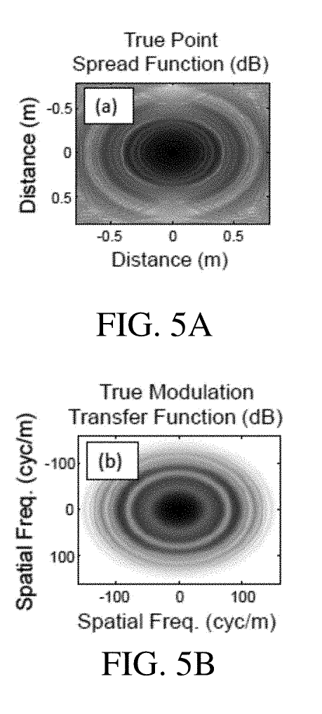

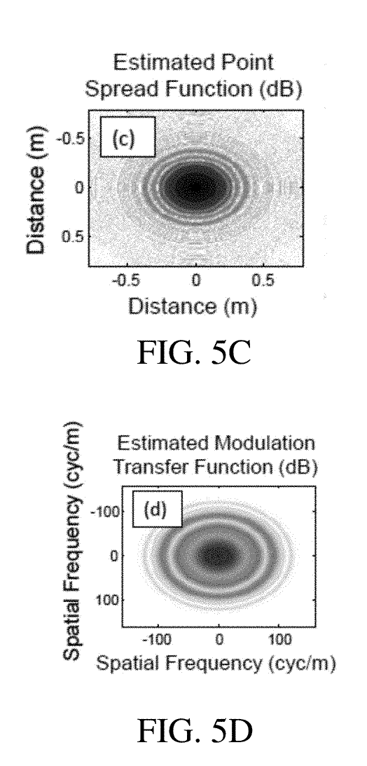

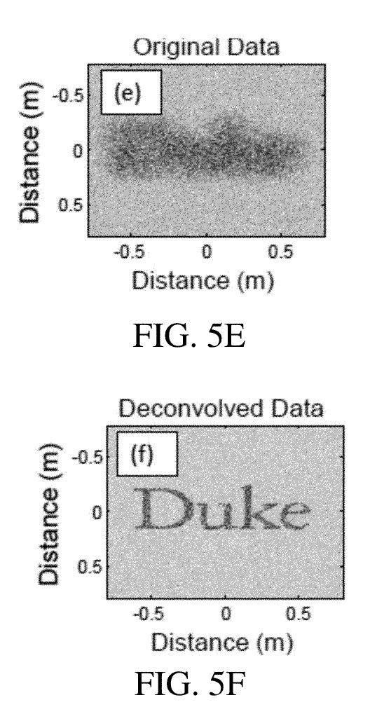

In order to test the method shown by the flowchart 300 in FIG. 3, a simulation was performed. The results of the simulation are shown in FIGS. 5A-F. Specifically, FIG. 5A shows a true point spread function of the simulation. FIG. 5B shows the true modulation transfer function. FIG. 5C shows the estimated point spread function. FIG. 5D shows the estimated modulation transfer function. FIG. 5E shows the magnitude of the synthetic data. FIG. 5F shows the reconstruction of the data.

In the simulation, an object was created based on the letters of “Duke.” Each point in the image was multiplied by a random unit-magnitude complex number to produce a speckle effect in the object. The speckle effect ensures that the object contains all spatial frequencies, whereas an object with large areas of uniform susceptibility has mostly low frequencies. Noise was added to the data so that the signal-to-noise ratio is 20 dB. The object was imaged through two layers of relative permittivity 4 and 9 both are 10 free-space wavelengths thick, with a gap of 3 wavelengths between the object and the interior layer. The method was applied to the field scattered by object through these layers, with the [symbol] ′ regularization shrinkage constant α of Equation 6 being equal to 0.2 and decreased to 0.01 over the course of 60 iterations of the method. The results are shown in FIGS. 5A-F. The magnitude of the point spread function and its Fourier transform the modulation transfer function (MTF) arc shown in logarithmic scale as FIGS. 5A and 5B, with black corresponding to 0 dB, or the maximum value of the function, and white corresponding to −30 dB. After applying the method to the original data, the estimated PSF and MIT are shown as FIGS. 5C and 5D. Finally, the magnitude of the original data is shown as FIG. 5E, with the object shape clearly broadened by diffraction and propagation through the layers, and FIG. 5F shows the reconstructed object.

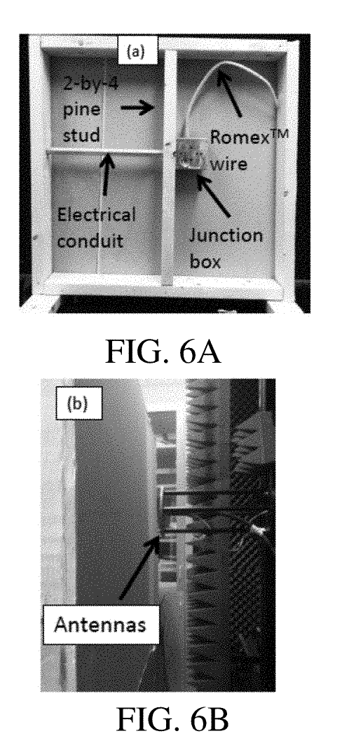

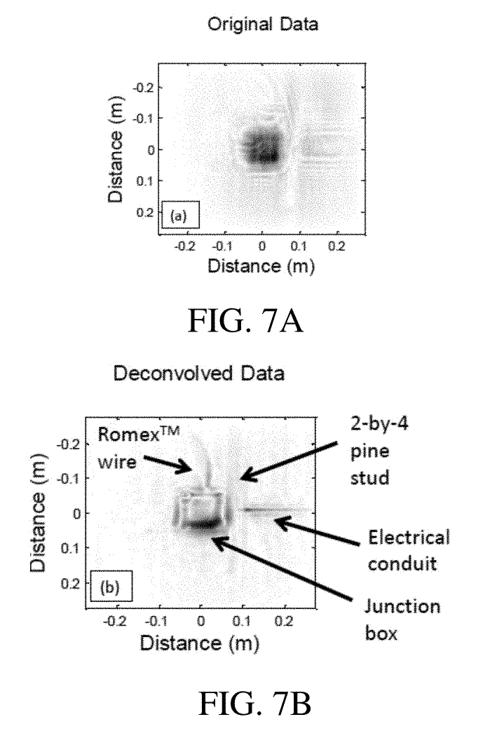

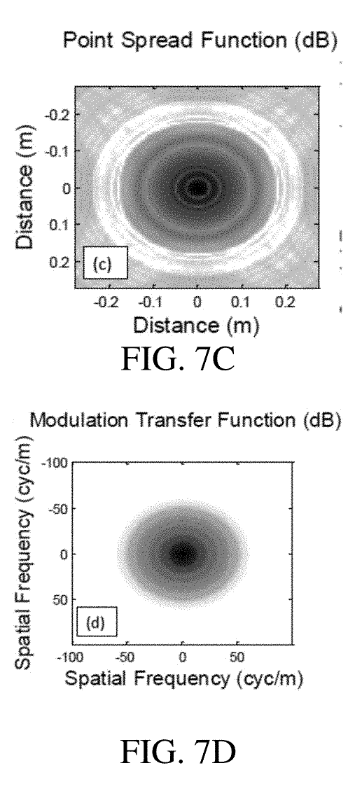

However, the simulation is an idealized case because while it contains noise, it does not contain the more realistic impediments of scattering within the layers or nonplanar layers. As a first test of a more realistic situation, a wall phantom was constructed to be similar to electrical ductwork in residential construction, a photograph of which is shown in FIG. 6A and FIG. 6B shows the phantom scanned by the antennas. A wall was constructed from common “two-by-four” pine studs with gypsum plasterboard screwed onto the studs. An electrical junction box was screwed onto a stud, and holes were bored through the studs through which an electrical conduit was routed. A Romex wire was routed from the electrical box vertically as well. The wall was imaged through the gypsum plasterboard, which was about 15 mm thick. The results are shown in FIGS. 7A-7D. FIG. 7A shows the magnitude of the original data for the wall, in which the electrical junction box can be discerned as a blurry object as well as the electrical conduit. After applying the method, with a being 0.05 times the maximum magnitude data point, and λ varying from 0.2 to 0.05 as the iterations proceed. FIG. 7B shows the deconvolution data for the wall. The results show the electrical box, conduit, and Romex wire clearly discernible. In addition, a pine stud can be seen vertically on the right side of the junction box, however, the reflection is comparatively weak from the wood because of its low density. This image is reconstructed from the backscattered signal at a single frequency, 19.39 GHz. FIG. 7C shows the estimated point spread function for the wall and FIG. 7D shows the estimated modulation transfer function for the wall.

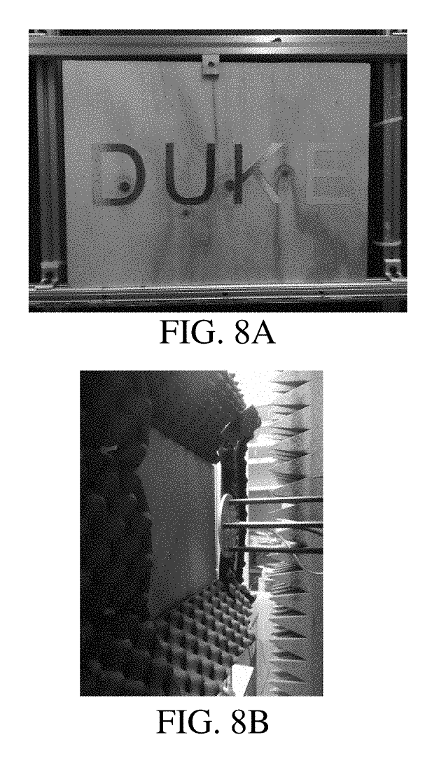

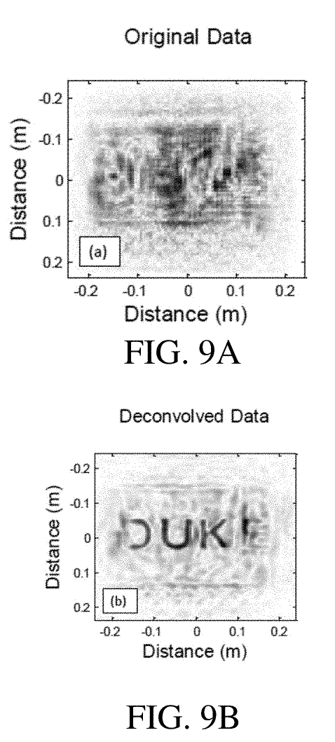

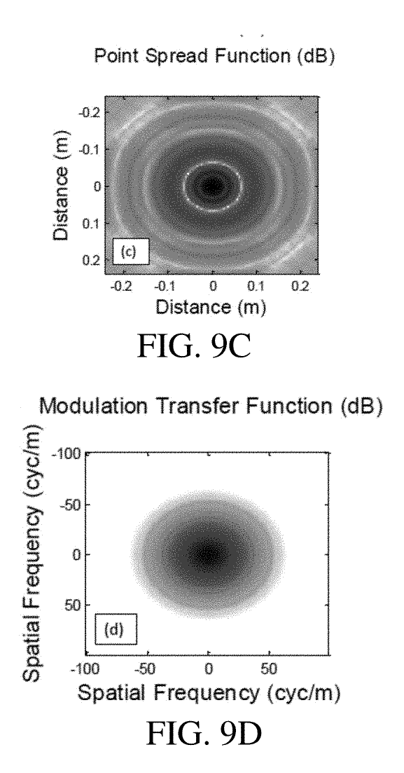

A second object, consisting of the letters “DUKE” in aluminum foil letters taped to a stack of six layers of plywood each 3 mm thick, as shown in FIG. 8A, and the corresponding phantom being scanned through the plywood wall is shown in FIG. 8B. This was imaged in an identical manner to the wall phantom shown in FIGS. 6A and 6B. The reconstruction method was applied to the reflection data at 19.39 GHz with a equal to 0.2 times the maximum magnitude data point, and λ varying from 0.2 to 0.017. The reconstruction shows that the method was successfully able to find the “DUKE” letters despite significant scattering from the plywood layers. The border of the plywood can also be seen in the image as well, but as the “DUKE” letters produce somewhat stronger scattering, the sparsity constraint optimizes the PSF to focus the letters. This is shown in FIGS. 9A-D. Specifically, FIG. 9A shows the original data for the DUKE object. FIG. 9B shows the deconvolution data for the DUKE object. FIG. 9C shows the estimated point spread function for the DUKE object. FIG. 9D shows the estimated modulation transfer function for the DUKE object.

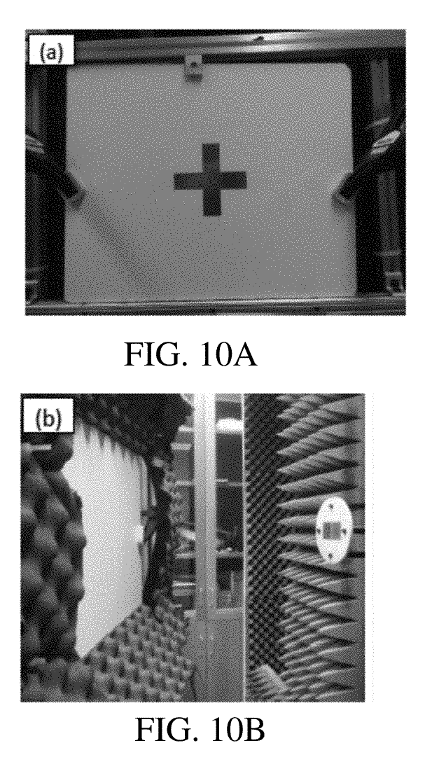

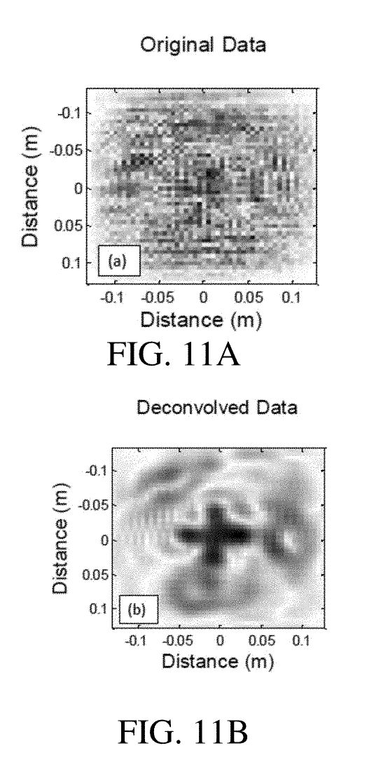

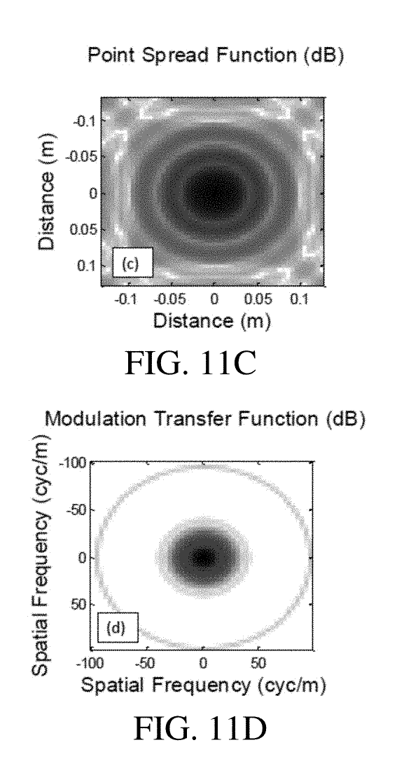

Another challenging object, a cross shaped target of two copper foil strips was taped onto the rear surface behind 80 mm of wood consisting of two 20 mm thick particle board layers and two 20 mm thick melamine laminated particle board layers as shown in FIG. 10A, and the corresponding phantom being scanned is shown in FIG. 10B. The scattering from the inside of the particle board layers is comparable to the scattering from the foil cross. Applying the method with α being 0.2 times the maximum magnitude data point, and λ varying from 0.2 to 0.05 as the iterations proceed, the reconstruction, as shown in FIGS. 11A-11D, is obtained. Specifically, FIG. 11A shows the original data for the cross-shaped target. FIG. 11B shows the deconvolution data for the cross-shaped target. FIG. 11C shows the estimated point spread function for the cross-shaped target. FIG. 11D shows the modulation transfer function for the cross-shaped target. The reconstruction frequency is at 17.59 GHz. The cross can be clearly discerned, despite the fact that it is unrecognizable in the raw data. The method should apply the correct phase to numerically focus the cross as well as the amplitude variations to the MTF to correct for interference effects in the layers.

There are some aspects of note in applying the method represented in FIG. 3. While the method is often able to focus the target without being provided the approximate distance to the object from the antenna, and in the foregoing demonstrations this information was not provided to the method, when imaging through highly scattering objects, even an approximate focusing of the data before application of the method can greatly help the method to enhance the object of interest rather than scatterers inside the wall. A pre-focused version Wₚ(x,y) can be computed from the data W(x,y) propagating the data by a distance d in the Fourier domain

⁻Wₚ(kₓ,k_{y})≅W(kₓ,k_{y})exp[id\sqrt{4k₀²−kₓ²−k_{y}²}]

in a manner analogous to the high pass filter of Equation 14. For thin walls, it is often the case that this focusing operation produces a somewhat recognizable image, however, for thick, highly scattering walls, the object may still appear highly obscured after refocusing but the deconvolution method improves the image. For practical use, the data may be rapidly refocused so that an operator may examine various refocused images to find the approximate object depth, and then apply the deconvolution method to enhance the image. Like any operation that maintains the circular symmetry of the convolution kernel, the deconvolution method may still be applied after refocusing.

Another aspect to note is that a smaller regularization constant A. tends to enhance high spatial frequencies, but oversharpening may occur if λ is too small. In practice λ should be selected on the basis of the required resolution. Because electrical conduit or plumbing tend to be large with lower spatial frequency features, it may be desirable to make the resolution coarser to remove out-of-focus scattering from inside the wall. The degree of sparsity α is usually best set to the minimum value required to enable sharpening to occur.

While there are challenges to practically exploiting blind deconvolution methods, blind deconvolution may be an effective way to cope with multilayer structures of unknown composition that are likely to occur in practical imaging situations. Circular symmetry is a strong constraint that can be applied to effectively remove the many effects of propagation through multilayer structures. For this reason, this method is likely to find use in imaging instruments used for construction, ground penetrating radar, or seismology.

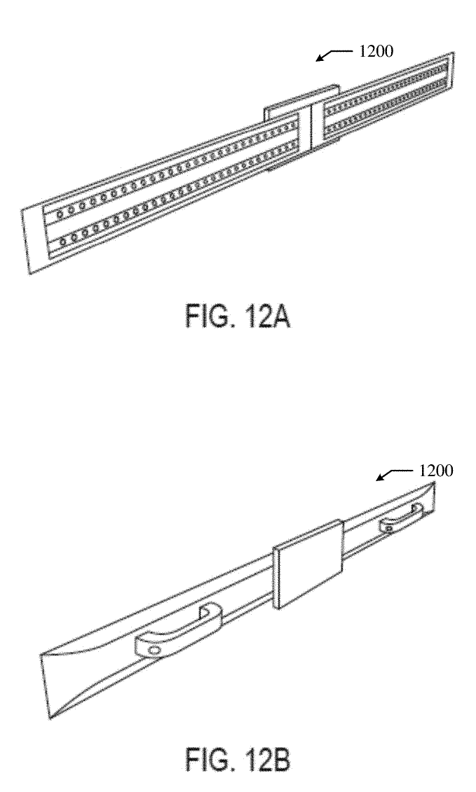

FIG. 12A shows a front perspective view of an example imaging apparatus 1200. The imaging apparatus 1200 can function according to an applicable apparatus for performing through medium imaging, such as the imaging apparatuses described herein. The imaging apparatus 1200 includes a surface forming a plane that includes a plurality of radiating elements and receiving elements. The radiating elements and receiving elements are arranged in two lines within the plane. In operation, this surface of the imaging apparatus 1200 can be placed on or within close proximity to a medium for purposes of obtaining one or more through images of the medium.

FIG. 12B shows a back perspective view of the imaging apparatus 1200. The back of the imaging apparatus 1200 includes two handles. These handles allow a user to position the imaging apparatus 1200 and potentially move the imaging apparatus 1200 in order to obtain one or more through images of a medium. Further, the back of the imaging apparatus 1200 includes a display. The display can be a removable display and potentially a personal device of a user of the imaging apparatus 1200. Using the display, a user can view one or more obtained through images, as the user operates the imaging apparatus 1200, e.g. moves the imaging apparatus 1200 along a medium.

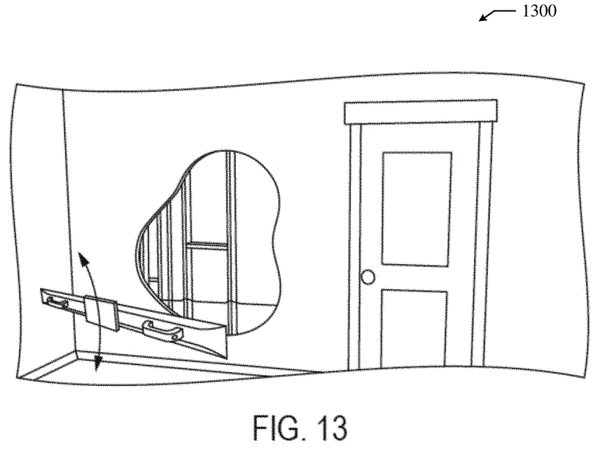

FIG. 13 shows an environment 1300 in which the imaging apparatus 1200 is operated. The environment 1300 includes a wall. The imaging apparatus 1200 can be placed in proximity to the wall and moved along the wall, e.g. as indicated by the arrows shown in FIG. 13. In turn, the imaging apparatus 1200 can be used to generate one or more through images of objects within the wall, as is shown in FIG. 13.

This disclosure has been made with reference to various exemplary embodiments including the best mode. However, those skilled in the art will recognize that changes and modifications may be made to the exemplary embodiments without departing from the scope of the present disclosure. For example, various operational steps, as well as components for carrying out operational steps, may be implemented in alternate ways depending upon the particular application or in consideration of any number of cost functions associated with the operation of the system, e.g., one or more of the steps may be deleted, modified, or combined with other steps.

While the principles of this disclosure have been shown in various embodiments, many modifications of structure, arrangements, proportions, elements, materials, and components, which are particularly adapted for a specific environment and operating requirements, may be used without departing from the principles and scope of this disclosure. These and other changes or modifications are intended to be included within the scope of the present disclosure.

The foregoing specification has been described with reference to various embodiments. However, one of ordinary skill in the art will appreciate that various modifications and changes can be made without departing from the scope of the present disclosure. Accordingly, this disclosure is to be regarded in an illustrative rather than a restrictive sense, and all such modifications are intended to be included within the scope thereof. Likewise, benefits, other advantages, and solutions to problems have been described above with regard to various embodiments. However, benefits, advantages, solutions to problems, and any element(s) that may cause any benefit, advantage, or solution to occur or become more pronounced are not to be construed as a critical, a required, or an essential feature or element. As used herein, the terms “comprises,” “comprising,” and any other variation thereof, are intended to cover a non-exclusive inclusion, such that a process, a method, an article, or an apparatus that comprises a list of elements does not include only those elements but may include other elements not expressly listed or inherent to such process, method, system, article, or apparatus. Also, as used herein, the terms “coupled,” “coupling,” and any other variation thereof are intended to cover a physical connection, an electrical connection, a magnetic connection, an optical connection, a communicative connection, a functional connection, and/or any other connection.

Those having skill in the art will appreciate that many changes may be made to the details of the above-described embodiments without departing from the underlying principles of the invention. The scope of the present invention should, therefore, be determined only by the following claims.

What is claimed is:

1. An apparatus for performing through medium imaging comprising:
one or more radiating elements comprising one or more artificially-structured materials configured to transmit a radiation pattern of electromagnetic energy into a medium; and
one or more receiving elements configured to receive backscattered energy from the radiation pattern of electromagnetic energy transmitted into the medium for generating one or more through images of the medium.

2-4. (canceled)

5. The apparatus of claim 1, wherein the one or more radiating elements and the one or more receiving elements are positioned in the apparatus along a line.

6. (canceled)

7. The apparatus of claim 5, wherein the one or more receiving elements are configured to receive the backscattered energy for forming the one or more through images of the medium in one-dimensional space with respect to the medium.

8. The apparatus of claim 5, wherein the apparatus is configured for movement along the medium and the one or more receiving elements are configured to receive the backscattered energy as the apparatus is moved for generating the one or more through images of the medium in two-dimensional space with respect to the medium.

9. The apparatus of claim 5, wherein the apparatus is configured for movement along the medium and the one or more receiving elements are configured to receive the backscattered energy as the apparatus is moved for generating the one or more through images of the medium in three-dimensional space with respect to the medium.

10. The apparatus of claim 1, wherein the one or more radiating elements and the one or more receiving elements are positioned in the apparatus along a plane.

11. (canceled)

12. (canceled)

13. The apparatus of claim 10, wherein the one or more receiving elements are configured to receive the backscattered energy for generating the one or more through images of the medium in two-dimensional space with respect to the medium as the apparatus is kept stationary with respect to the medium.

14. The apparatus of claim 10, wherein the one or more receiving elements are configured to receive the backscattered energy for generating the one or more through images of the medium in three-dimensional space with respect to the medium as the apparatus is kept stationary with respect to the medium.

15. The apparatus of claim 10, wherein the apparatus is configured for movement along the medium and the one or more receiving elements are configured to receive the backscattered energy as the apparatus is moved for generating the one or more through images of the medium in two-dimensional space with respect to the medium.

16. (canceled)

17. The apparatus of claim 10, wherein the apparatus is configured for movement along the medium and the one or more receiving elements are configured to receive the backscattered energy as the apparatus is moved for generating the one or more through images of the medium in three-dimensional space with respect to the medium.

18. (canceled)

19. The apparatus of claim 1, further comprising circuitry for generating the one or more through images of the media, wherein the circuitry for generating the one or more through images of the medium includes circuitry for generating the one or more through images based on a tracked moving position of the apparatus with respect to the medium.

20-43. (canceled)

44. The apparatus of claim 1, further comprising circuitry for generating the one or more through images of the medium from the backscattered energy received by the one or more receiving elements through blind deconvolution.

45. The apparatus of claim 44, wherein the circuitry is further configured to generate the one or more through images from the backscattered energy through blind deconvolution absent knowledge of characteristics of the medium.

46. The apparatus of claim 44, wherein the circuitry is further configured to generate the one or more through images from the backscattered energy by generating one or more image estimates of the one or more images from the backscattered energy by estimating a circularly symmetric Green's function that models transmission of the radiation pattern of the electromagnetic energy though the medium.

47. The apparatus of claim 46, wherein the circuitry is further configured to generate the one or more image estimates from a current image estimate by:
soft-thresholding the current image estimate to form a sharpened image of a new image estimate of the one or more image estimates;
identifying a point spread function (“PSF”) estimate using the current image estimate;
averaging the PSF estimate in an angular direction to generate an angular averaged PSF estimate;
identifying image estimate spatial frequencies of the new image estimate using the angular averaged PSF estimate and the current image estimate; and
generating the new image estimate based on the identified image estimate spatial frequencies of the new image estimate.

48-57. (canceled)

58. The apparatus of claim 1, wherein the one or more artificially-structured materials include one or more metamaterials.

59. The apparatus of claim 1, wherein the one or more artificially-structured materials include one or more subwavelength elements.

60-63. (canceled)

64. A method for performing through medium imaging comprising:
transmitting, using one or more radiating elements of an apparatus, a radiation pattern of electromagnetic energy into a medium as the apparatus remains static, wherein the one or more radiating element comprise one or more artificially-structured materials; and
receiving, using one or more receiving elements of the apparatus, backscattered energy from the radiation pattern of electromagnetic energy transmitted into the medium for generating one or more through images of the medium as the apparatus remains static.

65-67. (canceled)

68. The method of claim 64, wherein the one or more radiating elements and the one or more receiving elements are positioned in the apparatus along a line.

69. (canceled)

70. The method of claim 68, wherein the one or more receiving elements are configured to receive the backscattered energy for forming the one or more through images of the medium in one-dimensional space with respect to the medium.

71. The method of claim 64, wherein the one or more radiating elements and the one or more receiving elements are positioned in the apparatus along a plane.

72. (canceled)

73. (canceled)

74. The method of claim 71, wherein the one or more receiving elements are configured to receive the backscattered energy for generating the one or more through images of the medium in two-dimensional space with respect to the medium as the apparatus is kept stationary with respect to the medium.

75. The method of claim 71, wherein the one or more receiving elements are configured to receive the backscattered energy for generating the one or more through images of the medium in three-dimensional space with respect to the medium as the apparatus is kept stationary with respect to the medium.

76-100. (canceled)

101. The method of claim 64, further comprising generating the one or more through images of the medium from the backscattered energy received by the one or more receiving elements through blind deconvolution.

102. The method of claim 101, wherein the one or more through images are generated from the backscattered energy through blind deconvolution absent knowledge of characteristics of the medium.

103. The method of claim 101, wherein the one or more through images are generated from the backscattered energy by generating one or more image estimates of the one or more images from the backscattered energy by estimating a circularly symmetric Green's function that models transmission of the radiation pattern of the electromagnetic energy though the medium.

104. The method of claim 103, wherein the one or more image estimates are generated from a current image estimate by:
soft-thresholding the current image estimate to form a sharpened image of a new image estimate of the one or more image estimates;
identifying a point spread function (“PSF”) estimate using the current image estimate;
averaging the PSF estimate in an angular direction to generate an angular averaged PSF estimate;
identifying image estimate spatial frequencies of the new image estimate using the angular averaged PSF estimate and the current image estimate; and
generating the new image estimate based on the identified image estimate spatial frequencies of the new image estimate.

105-114. (canceled)

115. The method of claim 64, wherein the one or more artificially-structured materials include one or more metamaterials.

116. The method of claim 64, wherein the one or more artificially-structured materials include one or more subwavelength elements.

117-120. (canceled)

121. A method for performing through medium imaging comprising:
transmitting, using one or more radiating elements of an apparatus, a radiation pattern of electromagnetic energy into a medium as the apparatus is moved in relation to the medium, wherein the one or more radiating element comprise one or more artificially-structured materials; and
receiving, using one or more receiving elements of the apparatus, backscattered energy from the radiation pattern of electromagnetic energy transmitted into the medium for generating one or more through images of the medium as the apparatus is moved in relation to the medium.

122-124. (canceled)

125. The method of claim 121, wherein the one or more radiating elements and the one or more receiving elements are positioned in the apparatus along a line.

126. (canceled)

127. The method of claim 125, wherein the one or more receiving elements are configured to receive the backscattered energy as the apparatus is moved for generating the one or more through images of the medium in two-dimensional space with respect to the medium.

128. The method of claim 125, wherein the one or more receiving elements are configured to receive the backscattered energy as the apparatus is moved for generating the one or more through images of the medium in three-dimensional space with respect to the medium.

129. The method of claim 121, wherein the one or more radiating elements and the one or more receiving elements are positioned in the apparatus along a plane.

130. The method of claim 129, wherein the one or more radiating element and the one or more receiving elements are arranged at alternating positions within the plane.

131-133. (canceled)

134. The method of claim 129, wherein the one or more receiving elements are configured to receive the backscattered energy as the apparatus is moved for generating the one or more through images of the medium in three-dimensional space with respect to the medium.

135. (canceled)

136. (canceled)

137. The method of claim 121, further comprising generating the one or more through images of the media, wherein the one or more through images of the medium are generated based on a tracked moving position of the apparatus with respect to the medium.

138-160. (canceled)

161. The method of claim 121, further comprising generating the one or more through images of the medium from the backscattered energy received by the one or more receiving elements through blind deconvolution.

162. The method of claim 161, wherein the one or more through images are generated from the backscattered energy through blind deconvolution absent knowledge of characteristics of the medium.

163. The method of claim 161, wherein the one or more through images are generated from the backscattered energy by generating one or more image estimates of the one or more images from the backscattered energy by estimating a circularly symmetric Green's function that models transmission of the radiation pattern of the electromagnetic energy though the medium.

164. The method of claim 163, wherein the one or more image estimates are generated from a current image estimate by:
soft-thresholding the current image estimate to form a sharpened image of a new image estimate of the one or more image estimates;
identifying a point spread function (“PSF”) estimate using the current image estimate;
averaging the PSF estimate in an angular direction to generate an angular averaged PSF estimate;
identifying image estimate spatial frequencies of the new image estimate using the angular averaged PSF estimate and the current image estimate; and
generating the new image estimate based on the identified image estimate spatial frequencies of the new image estimate.

165-174. (canceled)

175. The method of claim 121, wherein the one or more artificially-structured materials include one or more metamaterials.

176. The method of claim 121, wherein the one or more artificially-structured materials include one or more subwavelength elements.

177-210. (canceled)
